(19) United States
(12) Patent Application Publication
(10) Pub. No.: US 2025/0245628 A1
(43) Pub. Date: Jul. 31, 2025

(54) TIME/DATE ADJUSTMENT APPARATUS, TIME/DATE ADJUSTMENT METHOD, AND STORAGE MEDIUM STORING PROGRAM

(71) Applicant: E4 Inc., Tokyo (JP)

(72) Inventor: Taichiro SUGIMOTO, Tokyo (JP)

(21) Appl. No.: 18/854,059

(22) PCT Filed: Feb. 10, 2023
(86) PCT No.: PCT/JP2023/004565

§ 371 Date: Oct. 3, 2024

(30) Foreign Application Priority Data
Apr. 7, 2022 (JP) 2022-063879

(51) Int. Cl. G06Q 10/1093; G06Q 10/1053

(52) U.S. Cl. CPC G06Q 10/1095; G06Q 10/1053

(57) ABSTRACT

A time/date adjustment apparatus is configured to set an adjustment condition template, and to perform adjustment of an assembly time/date, based on the adjustment condition template. The time/date adjustment apparatus regards existing plans designated by an adjustment initiator out of the existing plans already registered in schedule information managed by an external system as booking frames, and registers an adjustment condition including designation of the booking frames in the adjustment condition template. The time/date adjustment apparatus regards the booking frames satisfying the adjustment condition out of the booking frames as candidate time/dates, displays a time/date selection screen presenting the candidate time/dates in a terminal apparatus used by an adjustment partner, and in response to an operation of selecting one of the candidate time/dates of the adjustment partner on the time/date selection screen, determines the selected candidate time/date as the assembly time/date.

### TECHNICAL FIELD

The present invention relates to a time/date adjustment apparatus, a time/date adjustment method, and a program. The present invention claims priority based on Japanese Patent Application No. 2022-063879 filed on Apr. 7, 2022, the contents of which are incorporated herein by reference for designated states where incorporation of literature by reference is permitted.

### BACKGROUND ART

Conventionally, adjustment of a time/date (time and date) of an assembly in business requires a large number of steps such as checking of a schedule of each participant and securing a site, and is therefore considerably bothersome work taking time and efforts.

Note that, regarding checking of schedules of participants, it is considered that a calendar tool is referred to, as many businesspersons manage their plans using a calendar tool provided on the Internet in recent years.

Regarding the calendar tool, for example, PTL 1 provides the following description: “a schedule information sharing method including the steps of: performing membership application registration by each of a plurality of applicants and a plurality of users, the plurality of applicants applying for distribution of schedule information, the plurality of users using the schedule information of the distribution, the plurality of applicants and the plurality of users each being a member of a system that distributes and shares the schedule information via the Internet; executing by a scheduler performing schedule management below; disclosing and distributing, by the applicant, the schedule information to the user; registering, by the user, a target desiring distribution of the disclosed schedule information; and based on a registered desired distribution target of the user, synchronizing and presetting the schedule information related thereto to a calendar of all of user terminals.”

### CITATION LIST

### Patent Literature

PTL 1: JP 2019-219831 A

### SUMMARY OF INVENTION

### Technical Problem

In a technique described in PTL 1, a plurality of users being members of a system can share schedule information with each other, and use the schedule information for adjustment of a time/date of an assembly. However, even if the system is used, schedules of participants in a meeting or the like may be updated and changed from moment to moment. When a non-member of the system is included in the participants in the assembly, a schedule of the non-member needs to be individually checked, which makes it difficult to perform adjustment of a time/date of the assembly without causing an overlap between existing plans of each of the participants and a time/date on which the assembly is held, in other words, without causing a double booking.

When a company or the like holds a company information session, a seminar, or the like, it is often the case that an organizer registers plans of the company information session or the like in schedule information of participants on the side of the organizer and schedule information of a site to be used for the company information session or the like in advance to secure time/dates of the participants on the side of the organizer and the site in advance. In such a case, when bookings for the company information session or the like are regarded as adjustment of a time/date of an assembly, and existing plans registered in advance can be presented to applicants interested in participation in the company information session or the like as candidate time/dates to enable booking for participation, this enhances convenience for both of the organizer of the company information session or the like and the applicants interested in participation.

In general, in the company information session or the like, a plurality of applicants interested in participation are to take part on one time/date for holding, and thus it is desirable that bookings from a plurality of people can be accepted for one time/date for holding. However, there is not a system in which the existing plans registered in the schedule information in advance are regarded as the candidate time/dates of the assembly.

The present invention is made in view of such circumstances as described above, and has an object to forestall occurrence of a double booking on the side of an organizer by registering plans of an assembly in schedule information on the side of the organizer in advance, and allow adjustment of a time/date of the assembly related to a company information session or the like to be easily performed by regarding existing plans registered in advance as candidate time/dates and enabling acceptance of booking(s) from one or more people for one assembly time/date.

### Solution to Problem

The present application includes a plurality of solutions to at least a part of the problems described above, examples of which are described as follows.

In order to solve the problems described above, a time/date adjustment apparatus according to one aspect of the present invention includes: an adjustment condition setting unit configured to set an adjustment condition template to be repeatedly used for adjustment of time/dates of different assemblies; and a time/date adjustment unit configured to perform adjustment of an assembly time/date, based on the adjustment condition template. The adjustment condition setting unit regards existing plans designated by an adjustment initiator out of the existing plans already registered in schedule information managed by an external system as booking frames, and registers an adjustment condition including designation of the booking frames in the adjustment condition template. When an adjustment partner performs access based on access information corresponding to the adjustment condition template, the time/date adjustment unit regards the booking frames satisfying the adjustment condition out of the booking frames as candidate time/dates, displays a time/date selection screen presenting the candidate time/dates in a terminal apparatus used by the adjustment partner, and in response to an operation of selecting one of the candidate time/dates of the adjustment partner on the time/date selection screen, determines the selected candidate time/date as the assembly time/date.

The adjustment condition setting unit can set the schedule information designated by the adjustment initiator and managed by the external system to search target schedule information. The adjustment condition setting unit can search for the existing plans satisfying a search criterion set by the adjustment initiator out of the existing plans already registered in the search target schedule information. The adjustment condition setting unit can regard, as the booking frame, the existing plan selected by the adjustment initiator out of the existing plans as search results.

The adjustment initiator can perform processing of setting the search criterion and processing of selecting the booking frame out of the existing plans as the search results one or more times for the same adjustment condition template.

The adjustment condition setting unit can search for the existing plan including a search keyword as the search criterion in information related to the existing plan out of the existing plans already registered in the search target schedule information.

The adjustment condition setting unit can search for the existing plan within a search span as the search criterion out of the existing plans already registered in the search target schedule information.

The adjustment condition setting unit can regard the schedule information of a belonging member belonging to an organization same as the adjustment initiator or the schedule information of a site available to the belonging member designated by the adjustment initiator as the search target schedule information.

The adjustment condition setting unit can set an extraction span as the adjustment condition. When the adjustment partner performs access based on the access information, the time/date adjustment unit can regard the booking frames within the extraction span from a timing at which the adjustment partner performs access out of the booking frames as the candidate time/dates.

The adjustment condition setting unit can set a maximum number of people for booking as the adjustment condition. When the adjustment partner performs access based on the access information, the time/date adjustment unit can regard the booking frames in which the number of the adjustment partners who have made a booking is less than the maximum number of people for booking out of the booking frames as the candidate time/dates.

The time/date adjustment unit can add information related to the adjustment partner to the existing plan already registered in the schedule information corresponding to the determined assembly time/date and managed by the external system.

The time/date adjustment unit can notify the adjustment partner of the determined assembly time/date, and information related to a web meeting designated by the adjustment initiator for the adjustment condition template or the booking frame or information related to a place for holding.

A time/date adjustment method according to another aspect of the present invention includes: an adjustment condition setting step of setting an adjustment condition template to be repeatedly used for adjustment of time/dates of different assemblies; and a time/date adjustment step of performing adjustment of an assembly time/date, based on the adjustment condition template. The adjustment condition setting step includes regarding existing plans designated by an adjustment initiator out of the existing plans already registered in schedule information managed by an external system as booking frames, and registering an adjustment condition including designation of the booking frames in the adjustment condition template. When an adjustment partner performs access based on access information corresponding to the adjustment condition template, the time/date adjustment step includes regarding the booking frames satisfying the adjustment condition out of the booking frames as candidate time/dates, displaying a time/date selection screen presenting the candidate time/dates in a terminal apparatus used by the adjustment partner, and in response to an operation of selecting one of the candidate time/dates of the adjustment partner on the time/date selection screen, determining the selected candidate time/date as the assembly time/date.

A program according to yet another aspect of the present invention is configured to cause a computer to function as: an adjustment condition setting unit configured to set an adjustment condition template to be repeatedly used for adjustment of time/dates of different assemblies; and a time/date adjustment unit configured to perform adjustment of an assembly time/date, based on the adjustment condition template. The adjustment condition setting unit regards existing plans designated by an adjustment initiator out of the existing plans already registered in schedule information managed by an external system as booking frames, and registers an adjustment condition including designation of the booking frames in the adjustment condition template. When an adjustment partner performs access based on access information corresponding to the adjustment condition template, the time/date adjustment unit regards the booking frames satisfying the adjustment condition out of the booking frames as candidate time/dates, displays a time/date selection screen presenting the candidate time/dates in a terminal apparatus used by the adjustment partner, and in response to an operation of selecting one of the candidate time/dates of the adjustment partner on the time/date selection screen, determines the selected candidate time/date as the assembly time/date.

### Advantageous Effects of Invention

According to the present invention, a double booking can be forestalled by regarding existing plans registered in a schedule in advance as candidate time/dates, and booking(s) from one or more people can be easily accepted for one assembly time/date.

Problems, configurations, and effects other than those described above will become apparent in the following description of embodiments.

### BRIEF DESCRIPTION OF DRAWINGS

FIG. 1 is a diagram illustrating a configuration example of a time/date adjustment system according to one embodiment of the present invention.

FIG. 2 is a diagram illustrating an example of each of member information, user information, adjustment condition template information, and time/date adjustment information.

FIG. 3 is a sequence diagram for illustrating an example of processing at the time of use registration.

FIG. 4 is a sequence diagram for illustrating an example of adjustment condition template creation processing.

FIG. 5 is a diagram illustrating a display example of an adjustment condition template list screen.

FIG. 6 is a diagram illustrating a display example of a template management information input screen.

FIG. 7 is a diagram illustrating a display example of an assembly type selection screen.

FIG. 8 is a diagram illustrating a display example of a booking frame list screen.

FIG. 9 is a diagram illustrating another display example of the booking frame list screen.

FIG. 10 is a diagram illustrating a display example of a booking frame addition screen.

FIG. 11 is a diagram illustrating a display example of the booking frame list screen.

FIG. 12 is a diagram illustrating a display example of a booking acceptance setting screen.

FIG. 13 is a sequence diagram for illustrating an example of time/date adjustment processing.

FIG. 14 is a diagram illustrating a display example of the adjustment condition template list screen.

FIG. 15 is a diagram illustrating a display example of a comment confirmation screen.

FIG. 16 is a diagram illustrating a display example of a time/date selection screen.

FIG. 17 is a diagram illustrating a display example of a time/date confirmation screen.

FIG. 18 is a diagram illustrating a display example of a booker information input screen.

FIG. 19 is a diagram illustrating a display example of a time/date notification screen.

### DESCRIPTION OF EMBODIMENTS

One embodiment according to the present invention will be described below with reference to the drawings. Note that, in all the drawings for describing one embodiment, the same members are denoted by the same reference signs in principle, and repeated description thereof will be omitted. It goes without saying that, in the following embodiment, constituent elements (including element steps and the like) thereof are not necessarily essential, except for a case in which there is particular and explicit description, a case in which it is considered that those are obviously essential in principle, and the like. Concerning descriptions “to consist of A”, “to be composed of A”, “to have A”, and “to include A”, it goes without saying that, except for a case in which there is particular and explicit description that only the element is provided, and the like, elements other than the element are not to be excluded. Similarly, in the following embodiment, when there is a reference to a shape, a positional relationship, and the like of a constituent element and the like, a shape and the like that are substantially close to or similar to those shape and the like are included, except for a case in which there is particular and explicit description, a case in which it is considered that those are not obviously true in principle, and the like.

### <Time/Date Adjustment System 10 According to One Embodiment of Present Invention>

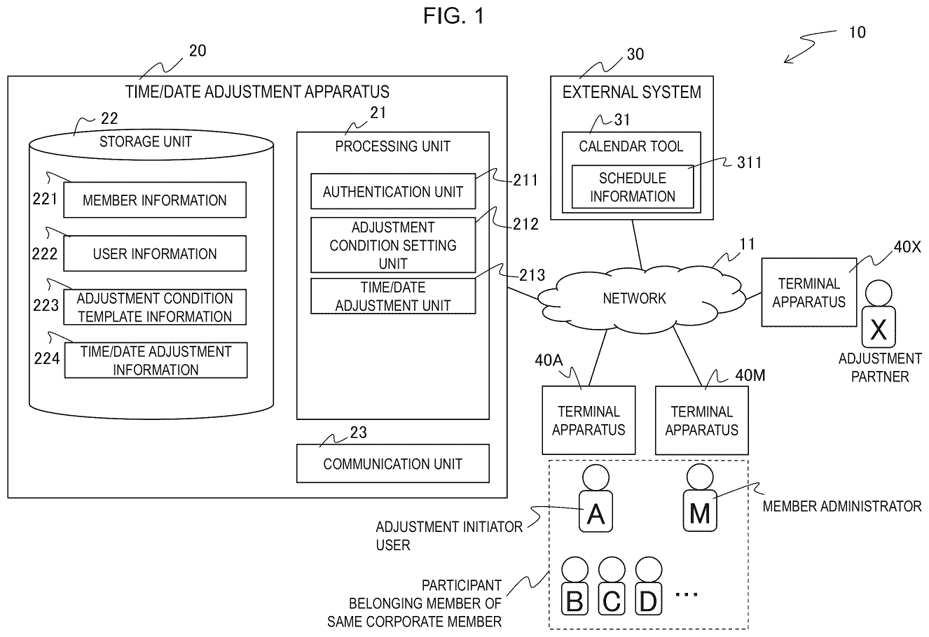

FIG. 1 illustrates a configuration example of a time/date adjustment system 10 according to one embodiment of the present invention.

The time/date adjustment system 10 includes a time/date adjustment apparatus 20, an external system 30, and terminal apparatuses 40A, 40M, and 40X, which are connected via a network 11.

The network 11 is a two-way communication network, as typified by the Internet, a mobile phone communication network, and the like.

The time/date adjustment apparatus 20 considers a reservation-based company information session, seminar, and the like as an assembly, for example, and assists acceptance of a booking on the side of the organizer related to the assembly and application for a booking of an applicant interested in participation. The applicant interested in participation who makes an application for a booking for the assembly is hereinafter referred to as an adjustment partner. Note that, in FIG. 1, only the adjustment partner X is illustrated as an adjustment partner; however, there are a plurality of adjustment partners. As participants on the side of the organizer of the company information session or the like, an adjustment initiator A and belonging members B, C, D, and the like (including a member administrator M (details will be described below)) of the organization to which the adjustment initiator A belongs (a company or the like; a corporate member to be described below) are assumed. Note that, in this specification, among persons to actually participate in the assembly, participants on the side of the organizer are defined as “participants” of the assembly, and unless otherwise explicitly noted, the adjustment partner X to participate in the assembly is not included in the “participants” (not referred to as a “participant”).

The external system 30 refers to a system that widely provides a calendar tool 31 as a web application for general consumers, corporations, and the like with or without a charge. As the calendar tool 31, for example, Google Calendar (trademark) and Microsoft Outlook (trademark) can be employed. The calendar tool 31 stores schedule information 311, in which action plans of a user of the calendar tool 31 and a booking status of assembly sites available to the user are registered. In other words, the external system 30 manages schedule information 311, in which action plans of a user of the calendar tool 31 and a booking status of assembly sites available to the user are registered.

The terminal apparatus 40A used by the adjustment initiator A includes a general computer, such as a personal computer and a smartphone, that can connect to the time/date adjustment apparatus 20 via the network 11. Similarly, the terminal apparatus 40M used by the member administrator M and the terminal apparatus 40X used by the adjustment partner X each include a general computer.

Note that, in the present embodiment, the adjustment partner X to participate in an assembly operates the terminal apparatus 40X; however, in actuality, a representative (a secretary or the like) of the adjustment partner X may operate the terminal apparatus 40X.

The adjustment initiator A is a belonging member of a company or the like that has conducted member registration and use registration (registration of information necessary for making a time/date adjustment function in the time/date adjustment apparatus 20 available) with the time/date adjustment apparatus 20. The company or the like that has conducted member registration with the time/date adjustment apparatus 20 is hereinafter referred to as a corporate member. Among belonging members belonging to the corporate member (company or the like), a belonging member having a user account of the time/date adjustment apparatus 20 is defined as a user. It is essential that the adjustment initiator A be a user. Thus, the adjustment initiator A may be hereinafter referred to as a user A. Note that an individual, not a company or the like, can also conduct use registration with the time/date adjustment apparatus 20. In that case, the individual who has conducted use registration is referred to as an individual member. The individual member and the user can be regarded as the same.

The member administrator M is a belonging member of an organization being the same corporate member as the adjustment initiator A, and manages a member account as a corporate member. The adjustment initiator A and the member administrator M may be different persons, or may be the same person.

The belonging members B, C, D, and the like belonging to the same corporate member as the member administrator M and the adjustment initiator A, other than the adjustment initiator A, may be users, but this is not essential.

Belonging members belonging to the corporate member of the time/date adjustment apparatus 20 manage their plans, using the calendar tool 31 provided by the external system 30. The corporate member of the time/date adjustment apparatus 20 manages the booking status of a meeting room, a reception room, a spare room, and the like available to the belonging members as an assembly site, using the calendar tool 31 provided by the external system 30.

Thus, in the present case, the calendar tool 31 stores the schedule information 311 in which each of plans of the adjustment initiator A and the like who may be participants on the side of the organizer of an assembly and the booking status of assembly sites available to the adjustment initiator A and the like is registered.

Specifically, the side of the organizer of an assembly registers a plurality of time/dates that may be booking frames for the company information session or the like in the schedule information 311 of the participants on the side of the organizer and the sites (meeting rooms or the like) as plans in advance. Accordingly, the schedule information 311 of the participants on the side of the organizer and the sites stores existing plans that may be booking frames for the company information session or the like. Moreover, the time/dates for the participants on the side of the organizer and the sites related to the company information session or the like are secured in the schedule information 311 in advance, and thus double booking can be forestalled.

Note that the adjustment partner X may be a user of the time/date adjustment apparatus 20, but this is not essential. The adjustment partner X may use the calendar tool 31, but this is not essential. The adjustment partner X may use a calendar tool provided by a vendor different from a vendor of the calendar tool 31 used by the adjustment initiator A.

The time/date adjustment apparatus 20 includes functional blocks of a processing unit 21, a storage unit 22, and a communication unit 23. The time/date adjustment apparatus 20 includes a general computer such as a server computer including a processor such as a central processing unit (CPU), a memory such as a dynamic random access memory (DRAM), a storage such as a hard disk drive (HDD) and a solid state drive (SSD), an input device such as a keyboard, a mouse, and a touch panel, an output device such as a display, and a communication module such as a network interface card (NIC) (all of which are not illustrated).

The processing unit 21 is implemented by the processor of the computer. The processing unit 21 includes functional blocks of an authentication unit 211, an adjustment condition setting unit 212, and a time/date adjustment unit 213. These functional blocks are implemented by the processor of the computer executing a predetermined program loaded in the memory. Note that a part or all of these functional blocks may be implemented as hardware by an integrated circuit or the like.

For example, the authentication unit 211 receives member registration performed by the member administrator M using the terminal apparatus 40M, and creates member information 221. For example, in response to a first login of a user performed by the adjustment initiator A using the terminal apparatus 40A, and when a predetermined condition is satisfied, the authentication unit 211 creates user information 222.

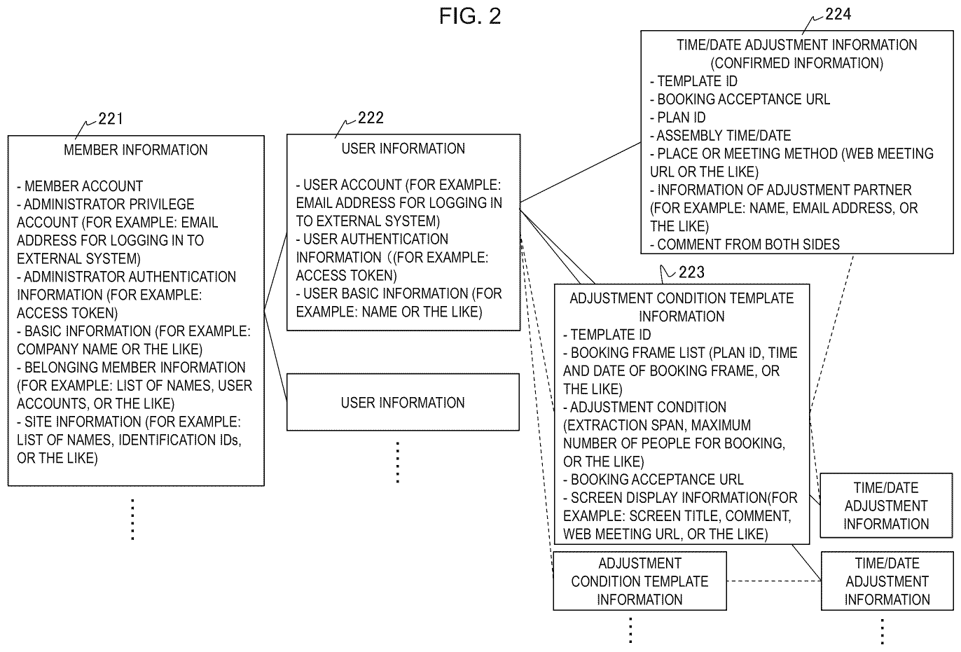

Moreover, the authentication unit 211 accesses the external system 30 via the network 11, and for example, performs authentication processing in accordance with a protocol such as OAuth, using an administrator privilege account included in the member information 221 and a user account included in the user information 222 corresponding to the adjustment initiator A (user A) (both in FIG. 2) stored in the storage unit 22. Note that the administrator privilege account and the user account may be used in first authentication processing, and in second and following authentication processing, administrator authentication information (an access token or the like) and user authentication information (an access token or the like) (both in FIG. 2) transmitted from the external system 30 after the first authentication processing has ended can be used.

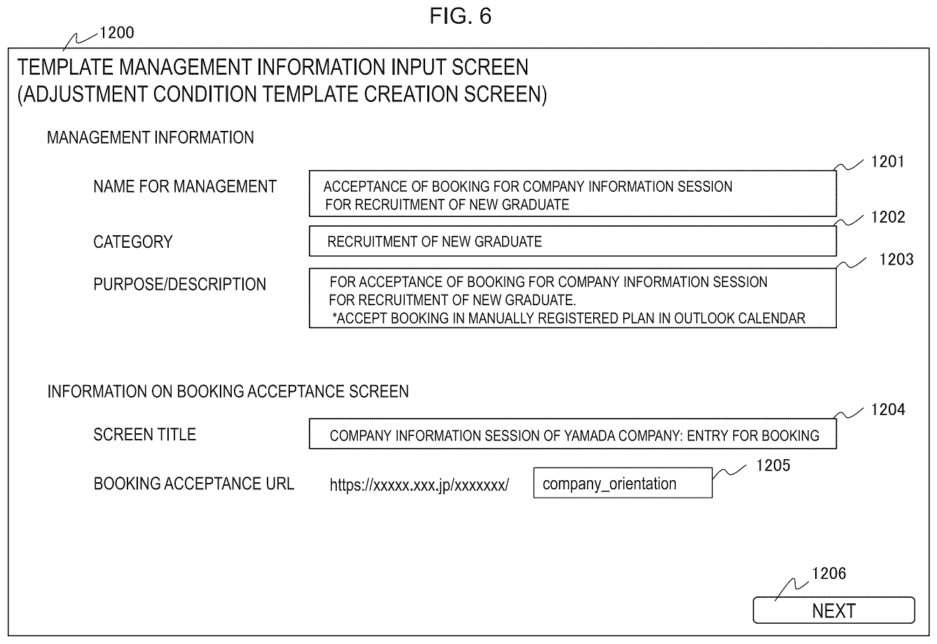

The adjustment condition setting unit 212 causes the terminal apparatus 40A to display a series of adjustment condition template creation screens (FIG. 6 to FIG. 12) for creating a template for an adjustment condition (hereinafter referred to as an adjustment condition template) including a plurality of items necessary for adjustment of a time/date of an assembly, and creates an adjustment condition template according to an input from the adjustment initiator A on the adjustment condition template creation screens. Then, the adjustment condition setting unit 212 causes the storage unit 22 to store the created adjustment condition template as adjustment condition template information 223 associated with the user information 222 corresponding to the adjustment initiator A.

Specifically, the adjustment condition setting unit 212 refers to schedule information (the schedule information 311 of the participants on the side of the organizer of an assembly and the sites) as a search target designated by the adjustment initiator A, and searches for existing plans satisfying a search criterion (for example, a search span, a search keyword, or the like) set by the adjustment initiator A. Then, the adjustment condition setting unit 212 registers an existing plan selected by the adjustment initiator A out of the searched existing plans in the adjustment condition template information 223 as a booking frame of the assembly. The adjustment condition template information 223 will be described below in detail.

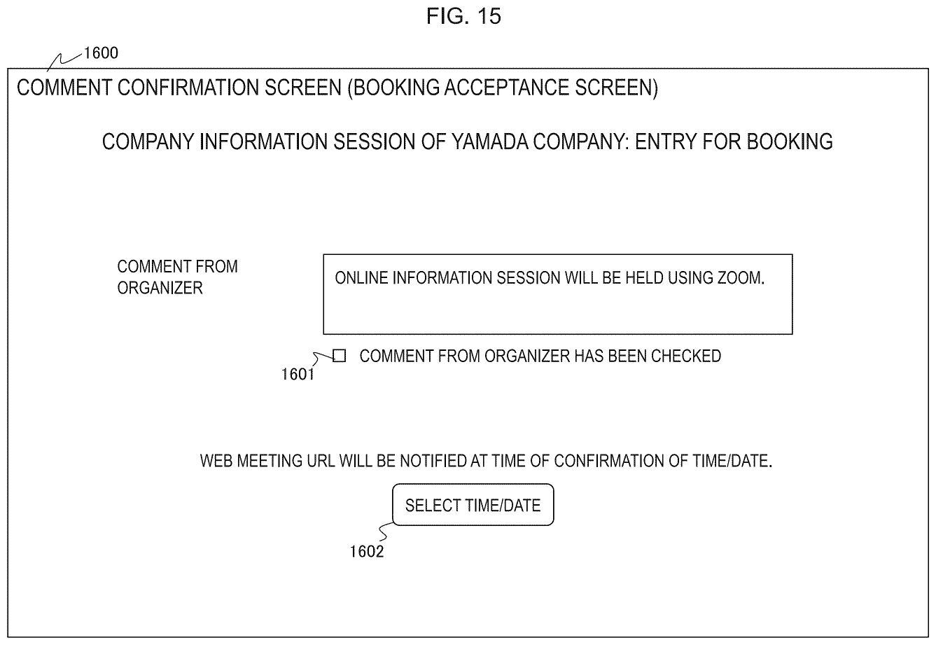

When the adjustment partner X accesses a booking acceptance Uniform Resource Locator (URL) to access a series of booking acceptance screens (FIG. 15 to FIG. 18) for performing a participation booking for the assembly set by the adjustment initiator A using the terminal apparatus 40X, at the time point, the time/date adjustment unit 213 refers to the schedule information 311 managed by the external system 30, and extracts booking frames that still exist as the existing plans whose time/dates have not been changed from the time point of being designated as the booking frames by the adjustment initiator A and satisfy the adjustment condition (an extraction span, a maximum number of people for booking, or the like) as candidate time/dates. Then, the time/date adjustment unit 213 causes the terminal apparatus 40X to display a time/date selection screen as the booking acceptance screen presenting the candidate time/dates. The booking acceptance URL corresponds to access information of the present invention.

When the adjustment partner X selects and confirms an assembly time/date out of the candidate time/dates displayed on the time/date selection screen, the time/date adjustment unit 213 creates time/date adjustment information 224, causes the storage unit 22 to store the time/date adjustment information 224 in association with the adjustment initiator A, and registers information of the adjustment partner X and the like. Moreover, the time/date adjustment unit 213 adds a name of the adjustment partner X and the like in a “notes” field or the like of the existing plan corresponding to the assembly time/date (booking frame) confirmed by the adjustment partner X in the schedule information 311 managed by the external system 30.

Note that, even during a short period of time until the adjustment partner X selects a candidate time/date displayed on the time/date selection screen and confirms the assembly time/date, for example, the number of bookers for the selected candidate time/date (booking frame) may reach the maximum number of people for booking. Thus, the time/date adjustment unit 213 performs final check that the number of bookers for the selected candidate time/date (booking frame) is less than the maximum number of people for booking, immediately before the adjustment partner X confirms the assembly time/date. Then, if the number of bookers for the selected candidate time/date (booking frame) has reached the maximum number of people for booking, for example, a message such as “The selected time/date is now full. Select a time/date again.” may be displayed on the terminal apparatus 40X, and the operation may be returned back to the time/date selection screen. In this manner, occurrence of a booking exceeding the maximum number of people for booking can be reduced.

The storage unit 22 is implemented by the memory and the storage of the computer. The storage unit 22 stores the member information 221, the user information 222, adjustment condition template information 223, and the time/date adjustment information 224. Note that the storage unit 22 may store information, data, and the like other than the various pieces of information described above.

The communication unit 23 is implemented by the communication module of the computer. The communication unit 23 connects to the external system 30, the terminal apparatuses 40A, 40M, and 40X, and the like via the network 11 and communicates various pieces of data and information therewith.

Note that a part or all of the above-described functional blocks constituting the time/date adjustment apparatus 20 may be implemented by hardware such as an integrated circuit. The time/date adjustment apparatus 20 may be implemented by a plurality of computers, and in that case, the above-described functional blocks may be distributedly deployed in the plurality of computers.

Next, FIG. 2 illustrates an example of the member information 221, the user information 222, the adjustment condition template information 223, and the time/date adjustment information (confirmation information) 224 stored in the storage unit 22.

The member information 221 includes information related to a corporate member that has conducted member registration with the time/date adjustment apparatus 20. The member information 221 includes information related to a corporate member to be added through use registration of the corporate member with the time/date adjustment apparatus 20. Specifically, the member information 221 includes a member account, an administrator privilege account, administrator authentication information, basic information, belonging member information, and site information.

The member account is information for the member administrator M or the like of the corporate member (company or the like) to log in to the time/date adjustment apparatus 20. The administrator privilege account is information for the member administrator M or the like of the corporate member (company or the like) to access the external system 30 by using the administrator privileges. Note that the member account is desirably common to, but may be different from, the administrator privilege account (for example, an email address of the member administrator M or the like). When the member account and the administrator privilege account are common to each other, registration of the administrator privilege account with the member information 221 may be omitted.

The administrator authentication information is an access token or the like that is obtained from the external system 30 as success results of the authentication processing when the authentication unit 211 of the time/date adjustment apparatus 20 performs the authentication processing with the external system 30 for the first time, using the administrator privilege account. After the administrator authentication information is obtained, the authentication unit 211 can more promptly perform the authentication processing with the external system 30 by using the administrator authentication information, without using the administrator privilege account.

The basic information is a name of the corporate member (a company name or the like) or the like. The basic information is recorded at the time of member registration, and can be changed after the member registration. The belonging member information is a list of names of belonging members belonging to a company or the like being the corporate member, user accounts for the belonging members to access the external system 30, and the like. The belonging member information is acquired from the external system 30 and then recorded on an assumption that the belonging members of the corporate member who may be participants on the side of the organizer of an assembly already use the calendar tool 31.

The site information is a list of names of sites, such as a meeting room, a reception room, and a spare room, available to the belonging members belonging to the corporate member for an assembly, identification IDs of the sites in the external system, and the like. The site information is acquired from the external system 30 and then recorded on an assumption that the schedules of all of the sites necessary for time/date adjustment are already managed by the calendar tool 31.

Note that the belonging member information and the site information are information that can be partially or entirely acquired from the external system 30 only when the external system 30 is accessed using the administrator privilege account, and cannot be acquired (it is to be noted that the information can be partially acquired in some cases depending on a type of the external system 30) when an account not having the administrator privileges is used instead of the administrator privilege account or when the external system 30 is accessed using an account that has privileges equivalent to the administrator privilege account but is used as a user account, for example.

The user information 222 includes information related to a user who has conducted use registration of the time/date adjustment apparatus 20 among the belonging members belonging to the corporate member. The user information 222 is created when each user logs in to the time/date adjustment apparatus 20 for the first time, succeeds in the authentication processing with the external system 30, and it is confirmed that the user is included in the belonging member information of the member information 221, and is then associated with the member information 221.

The user information 222 includes a user account, user authentication information, and user basic information.

The user account is information for the user, such as the adjustment initiator A, to log in to the time/date adjustment apparatus 20. The user account is desirably common to, but may be different from, an account for the user to access the external system 30. The following description will be given based on an assumption that the user account is common to an account for accessing the external system 30.

The user authentication information is an access token or the like that is obtained from the external system 30 as success results of the authentication processing when the authentication unit 211 performs the authentication processing with the external system 30 for the first time, using the user account. After the user authentication information is obtained, the authentication unit 211 can more promptly perform the authentication processing with the external system 30, using the user authentication information, without using the user account.

The user basic information is a name of the user or the like, and is read from the belonging member information of the member information 221 based on the user account used by the user in logging in to the time/date adjustment apparatus 20 for the first time, and is then recorded. The user basic information recorded in the user information 222 may be able to be edited by the user themselves.

The adjustment condition template information 223 is created in association with the user information 222. The adjustment condition template information 223 includes a template ID for uniquely identifying adjustment condition template information 223, which may be a plurality of pieces of adjustment condition template information 223, a booking frame list (a plan ID of an existing plan, a date and time of a booking frame, and the like), an adjustment condition designated by a user in advance depending on a purpose of an assembly (an extraction span, the maximum number of people for booking, and the like), a booking acceptance URL, and screen display information (a title of a booking acceptance screen, a comment, a web meeting URL, and the like).

Note that the adjustment condition template information 223 is created by the user and is thus associated with the user information 222; however, for example, the adjustment condition template information 223 may be associated with the member information 221, such that the adjustment condition template information 223 may be shared between users belonging to the corporate member corresponding to the member information 221. An adjustment condition template created by one user may be used by another user.

When the adjustment partner X completes a booking for an assembly, the time/date adjustment information 224 is created for each booking made by the adjustment partner X in association with the user information 222 corresponding to each user and the adjustment condition template information 223. Note that, considering that a user different from the user who has created the adjustment condition template adjusts a time/date using the adjustment condition template, the time/date adjustment information 224 may be directly associated with the member information 221 of a corporate member to which the user belongs.

The time/date adjustment information 224 records the template ID, the booking acceptance URL, the plan ID of the existing plan, the confirmed date and time of the assembly, a place or a meeting method (the web meeting URL and the like), information of the adjustment partner X who has made a booking (a name, an email address, and the like), comments from both of the adjustment initiator A and the adjustment partner X, and the like.

### <Processing Performed by Time/Date Adjustment System 10 at Time of Use Registration>

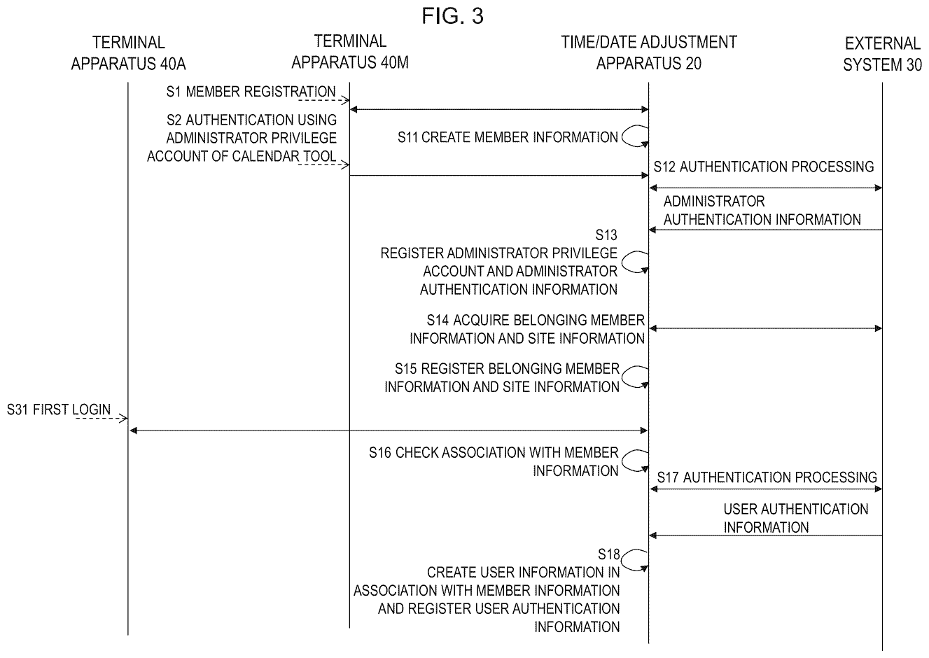

Next, FIG. 3 is a sequence diagram for illustrating an example of processing performed by the time/date adjustment system 10 at the time of use registration.

As an assumption, the calendar tool 31 provided by the external system 30 is used for schedule management of the belonging members of the corporate member to which the adjustment initiator A and the member administrator M belong and schedule management of the sites available to the belonging members for the assembly. The external system 30 already manages the belonging member information and the site information recorded in the member information 221. Further, the external system 30 supplies, as its specifications, at least one of the belonging member information and the site information recorded in the member information 221 to the time/date adjustment apparatus 20, in response to a request from the time/date adjustment apparatus 20 accessed using the administrator privilege account (or the administrator authentication information).

First of all, when the member administrator M requests member registration with the time/date adjustment apparatus 20 via the network 11 by using the terminal apparatus 40M (Step S1), the authentication unit 211 of the time/date adjustment apparatus 20 creates the member information 221 and records the member information 221 in the storage unit 22 (Step S11). Note that, here, the created member information 221 includes only the member account and the basic information, and does not include the administrator privilege account, the administrator authentication information, the belonging member information, and the site information.

Next, when the member administrator M inputs the administrator privilege account for the external system 30 and requests the authentication processing with the time/date adjustment apparatus 20 (Step S2), next, the authentication unit 211 performs the authentication processing with the external system 30, using the administrator privilege account (Step S12).

Note that, as a modification, Steps S1 and S11 may be executed after execution of Steps S2 and S12.

Then, the administrator authentication information (access token or the like) is transmitted from the external system 30 to the time/date adjustment apparatus 20 as success results of the authentication processing of Step S12, and thus, next, the authentication unit 211 registers the administrator privilege account and the administrator authentication information in the member information 221 created and recorded in Step S11 (Step S13). Note that, for the authentication processing, OAuth can be used, for example, and by having the member administrator M input a password to the external system 30 temporarily without using the authentication unit 211, the administrator privilege account input by the member administrator M is authenticated by the external system 30. The same holds true for the authentication processing performed by other persons such as the adjustment initiator A.

Next, the authentication unit 211 connects to the external system 30 by using the administrator authentication information of the member information 221, and acquires the belonging member information and the site information of the corporate member to which the member administrator M belongs, which are managed by the external system 30 (Step S14). Next, the authentication unit 211 registers the belonging member information and the site information acquired in Step S14 in the member information 221 created and recorded in Step S11 (Step S15).

Subsequently, when the adjustment initiator A uses the user account of the adjustment initiator A and logs in to the time/date adjustment apparatus 20 via the network 11 for the first time, using the terminal apparatus 40A (Step S31), the authentication unit 211 of the time/date adjustment apparatus 20 checks presence of the member information 221 in which the belonging member information including the user account of the adjustment initiator A is registered, and acquires the name (user basic information) of the adjustment initiator A from the belonging member information (Step S16). Next, the authentication unit 211 performs the authentication processing with the external system 30, using the user account of the adjustment initiator A (Step S17).

Then, the user authentication information (access token or the like) is transmitted from the external system 30 to the time/date adjustment apparatus 20 as success results of the authentication processing of Step S17, and thus, next, the authentication unit 211 creates the user information 222 corresponding to the adjustment initiator A, records the user information 222 in the storage unit 22 in association with the member information 221 checked in Step S16, and registers the user account and the user authentication information of the adjustment initiator A and the user basic information acquired in Step S16 in the user information 222 (Step S18). Through the above processing, the processing at the time of use registration ends.

According to the processing at the time of use registration described above, the member information 221 of the corporate member to which the adjustment initiator A belongs and the user information 222 of the adjustment initiator A are associated with each other. Thus, after the processing, even if the member administrator M is not logged in to the time/date adjustment apparatus 20, on the condition that the adjustment initiator A being a user is logged in to the time/date adjustment apparatus 20, for example, the time/date adjustment unit 213 of the time/date adjustment apparatus 20 can refer to and update the schedule information 311 in which plans of the adjustment initiator A and the belonging members B, C, and D and the like belonging to the same corporate member as the adjustment initiator A are registered and the schedule information 311 in which plans of assembly sites (a meeting room and the like) available to the adjustment initiator A and the belonging members B, C, and D and the like belonging to the same corporate member as the adjustment initiator A are registered, which are stored in the external system 30, via a web application programming interface (API).

Note that, in the processing at the time of use registration described above, the user information of the user belonging to the corporate member is generated, on an assumption that the member information 221 of the corporate member is present. As a modification, when an organization to which a certain individual belongs is not the corporate member and the member information 221 thereof is thus not present, the certain individual may log in to the time/date adjustment apparatus 20 and create the user information 222, and the individual may subsequently perform anew the authentication processing with the external system 30 by using the administrator privilege account, and the member information 221 associated with the individual may be thereby generated based on the user information 222 of the individual, with the individual being regarded as the corporate member and a user account of the individual being regarded as a member account. In this case, the individual as the corporate member has the administrator privilege account, and can thus acquire the belonging member information and the site information of the organization to which the individual belongs from the external system 30.

In the present embodiment, the belonging member information and the site information acquired from the external system 30 are registered in the member information 221 stored in the storage unit 22; however, without the belonging member information and the site information being registered in the member information 221, the belonging member information and the site information may be acquired from the external system 30 every time the pieces of information need to be referred to.

In the present embodiment, the belonging member information and the site information are acquired using the administrator privilege account on the external system 30; however, when it is difficult to use the administrator privilege account of the external system 30 from the perspective of security and the like, the belonging member information and the site information may be directly registered with the time/date adjustment apparatus 20 without using the administrator privilege account on the external system 30. For example, the member administrator M or the user of the corporate member may directly register the belonging member information and the site information with the time/date adjustment apparatus 20 by uploading data recording the belonging member information and the site information with the time/date adjustment apparatus 20, directly inputting the data on a screen for use registration displayed on the terminal apparatus 40M or the terminal apparatus 40A by the time/date adjustment apparatus 20, or the like. By using the user account privileges of the member administrator M or the user of the corporate member without using the administrator privilege account, only the belonging member information and the site information that can be acquired from the external system 30 may be acquired from the external system 30 and registered with the time/date adjustment apparatus 20.

To address a case in which the belonging member information or the site information registered in the member information 221 needs to be edited (added, changed, and deleted), the member administrator M may log in to the time/date adjustment apparatus 20 by using the member account, cause the terminal apparatus 40M to display a belonging member information editing screen or a site information editing screen (neither of which is illustrated) through a predetermined operation, and thereby enable editing of the belonging member information or the site information.

Note that, in the belonging member information to be registered with the time/date adjustment apparatus 20 by the member administrator M, information of an outsider (an outside partner, an employee of an affiliated company, or the like) who does not belong to the same organization as the adjustment initiator A and the member administrator M can be included. In some calendar tools, when an outsider included in the belonging member information uses the same type of calendar tool as the organization to which the adjustment initiator A belongs and has special calendar sharing settings with the adjustment initiator A or the organization to which the adjustment initiator A belongs, the schedule information 311 of the outsider can be referred to and updated, using the authentication information of the adjustment initiator A and an ID for identifying the outsider in the external system 30. In other words, the outsider can be regarded equally as a participant in the assembly belonging to the same organization as the adjustment initiator A. Note that, even if there is an outsider in the belonging member information to be registered with the time/date adjustment apparatus 20 by the member administrator M, on the condition that the schedule information 311 managing plans of the outsider cannot be referred to in the authentication information of the adjustment initiator A, this may be considered an error and the outsider may be arranged not to be regarded as a participant. Note that, in the present embodiment, the outsider included in the belonging member information to be registered with the time/date adjustment apparatus 20 by the member administrator M is assumed to have special calendar sharing settings with the adjustment initiator A or the organization to which the adjustment initiator A belongs and be able to be regarded as a participant designated by the adjustment initiator A, and is described being regarded as the “belonging member belonging to the same organization as the adjustment initiator A.”

### <Adjustment Condition Template Creation Processing Performed by Time/Date Adjustment System 10>

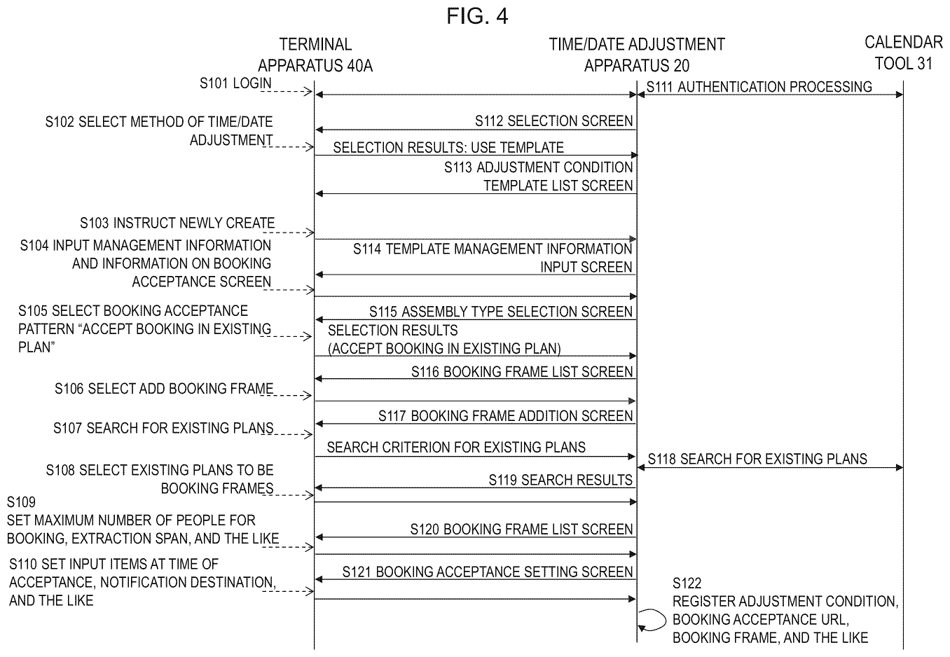

Next, FIG. 4 is a sequence diagram for illustrating an example of adjustment condition template creation processing performed by the time/date adjustment system 10.

A user such as the adjustment initiator A can create the adjustment condition template, depending on a purpose of the assembly, such as “for first interview for recruitment of new graduate”, “for second interview for recruitment of new graduate”, “for final interview for recruitment of new graduate”, and “for acceptance of booking for company information session”, for example.

First of all, when the adjustment initiator A logs in to the time/date adjustment apparatus 20 via the network 11, using the terminal apparatus 40A (Step S101), next, the authentication unit 211 of the time/date adjustment apparatus 20 performs the authentication processing with the external system 30, using the user account (or the user authentication information) included in the user information 222 corresponding to the adjustment initiator A stored by the storage unit 22 (Step S111).

Next, the adjustment condition setting unit 212 of the time/date adjustment apparatus 20 causes the terminal apparatus 40A to display a selection screen (not illustrated) for selecting either “use template” or “customized adjustment” as a method of time/date adjustment (Step S112). Here, “use template” indicates a method for performing time/date adjustment using the adjustment condition template that can be repeatedly used for a plurality of assemblies on different time/dates. “Customized adjustment” indicates a method for performing time/date adjustment by setting the adjustment condition for each assembly. The following will describe a case in which the adjustment initiator A selects “use template” in detail, and description of a case of selecting “customized adjustment” will be omitted.

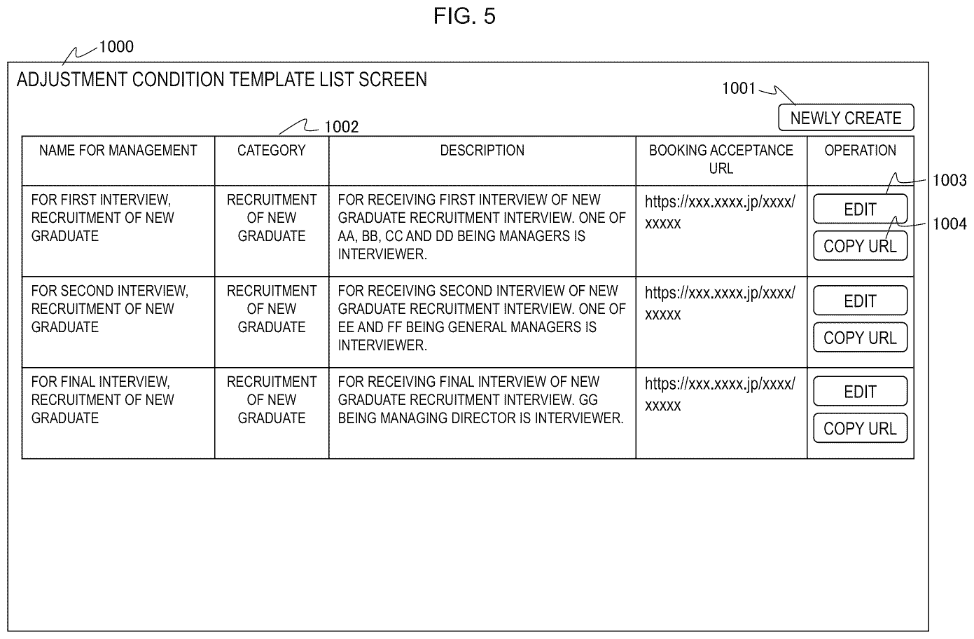

Next, when the adjustment initiator A selects “use template” as a method of time/date adjustment on the selection screen (Step S102), next, the adjustment condition setting unit 212 of the time/date adjustment apparatus 20 refers to the adjustment condition template information 223 associated with the user information 222 corresponding to the adjustment initiator A, and causes the terminal apparatus 40A to display an adjustment condition template list screen 1000 (FIG. 5) presenting a list of adjustment condition templates having been created by the current time point and being available to the adjustment initiator A (Step S113).

FIG. 5 illustrates a display example of the adjustment condition template list screen 1000 displayed in the terminal apparatus 40A.

The adjustment condition template list screen 1000 is provided with a “newly create” button 1001 for instructing proceeding to a template management information input screen 1200 (FIG. 6), on which a new adjustment condition template can be created, and a template list 1002 presenting a list of adjustment condition templates available to the adjustment initiator A. In the template list 1002, a name for management, a category, a description, and a booking acceptance URL are displayed for each template. Moreover, the template list 1002 is provided with an “edit” button 1003 for instructing proceeding to a screen (not illustrated), on which a created adjustment condition template can be edited, and a “URL copy” button 1004 for instructing copying of the booking acceptance URL for each template.

FIG. 4 is referred to again. When the adjustment initiator A performs operation on the “newly create” button 1001 on the adjustment condition template list screen 1000 displayed in the terminal apparatus 40A (Step S103), next, the adjustment condition setting unit 212 causes the terminal apparatus 40A to display the template management information input screen 1200 (FIG. 6) as the adjustment condition template creation screen (Step S114).

FIG. 6 illustrates a display example of the template management information input screen 1200.

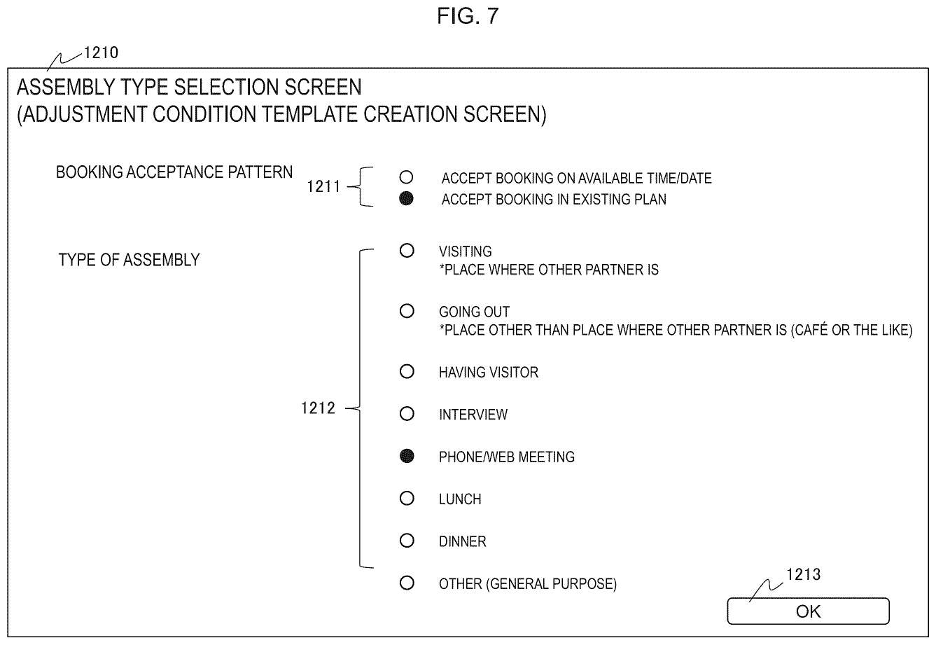

The template management information input screen 1200 is provided with an input field 1201 for inputting the name for management of the template, an input field 1202 for inputting the category of the template, and an input field 1203 for inputting the purpose, the description, and the like of the template, as management information for the adjustment initiator A and a user of the corporate member to which the adjustment initiator A belongs to manage the template. The template management information input screen 1200 is provided with an input field 1204 for inputting the screen title, an input field 1205 for inputting the booking acceptance URL, as information on the booking acceptance screen for accepting a booking from the adjustment partner X, and a “next” button 1206 for instructing proceeding to an assembly type selection screen 1210 (FIG. 7) to be displayed next.

Although the booking acceptance URL needs to be determined by the adjustment initiator A or the like to be input to the input field 1205, the adjustment condition setting unit 212 may automatically generate the booking acceptance URL to be reflected in the input field 1205. Note that, regarding the booking acceptance URL, in response to the adjustment partner X performing access based on the booking acceptance URL, the time/date adjustment unit 213 needs to be able to uniquely identify the adjustment condition template information 223 corresponding to the booking acceptance URL. Thus, at the time of creating the adjustment condition template, the adjustment condition setting unit 212 checks that the determined booking acceptance URL is unique in the time/date adjustment apparatus 20.

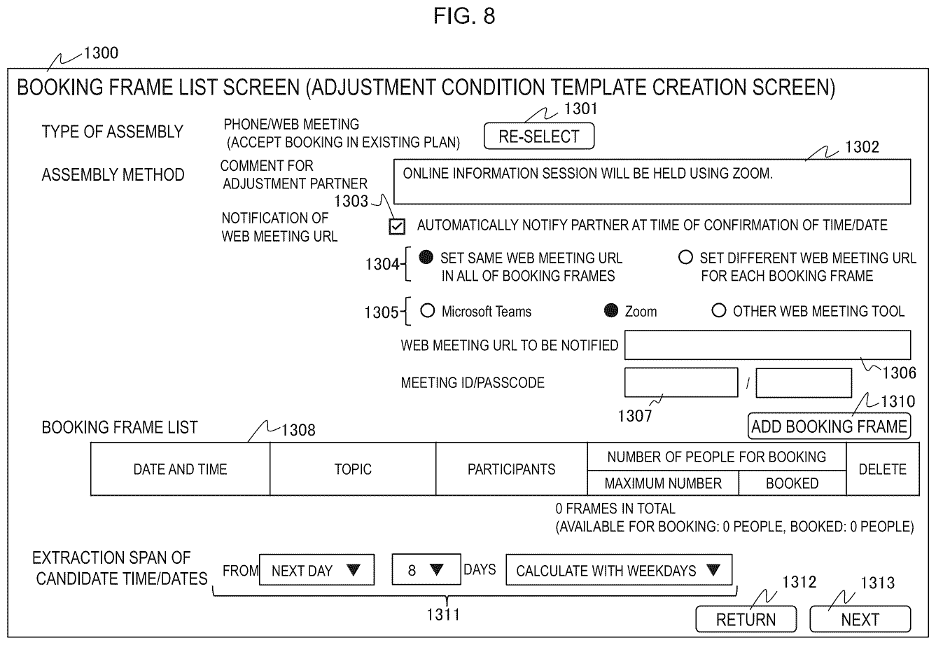

FIG. 7 illustrates a display example of the assembly type selection screen 1210 as the adjustment condition template creation screen. The assembly type selection screen 1210 is provided with a radio button 1211 for selecting “accept booking on available time/date” or “accept booking in existing plan” as a booking acceptance pattern, a radio button 1212 for selecting a type of assembly, and an “OK” button 1213 for instructing proceeding to a subsequent booking frame list screen 1300 (FIG. 8 and the like).

When the booking acceptance pattern “accept booking in existing plan” is selected in the radio button 1211, an existing plan designated by the adjustment initiator A out of the existing plans registered in the schedule information 311 of the belonging member of the corporate member to which the adjustment initiator A belongs or the sites is regarded as a booking frame, and booking frames satisfying a predetermined adjustment condition are presented to the adjustment partner X as candidate time/dates of the assembly (details will be described below). In contrast, when the booking acceptance pattern “accept booking on available time/date” is selected, available time/dates of the participants satisfying the predetermined adjustment condition are regarded as candidate time/dates to be presented to the adjustment partner X (details will be omitted).

The type of assembly is an item for behavior control for adjusting a place for holding the assembly with the adjustment partner X or notifying the adjustment partner X thereof. For example, when “phone/web meeting” is selected as the type of assembly, “web meeting URL (and a passcode necessary for participation and the like)” being the place for holding in the web meeting is set to the adjustment condition template, and the adjustment partner X is notified of the “web meeting URL.”

For example, when “going out” or “having visitor” is selected as the type of assembly, the place for holding (an address, a building name, or the like) is set to the adjustment condition template, and the adjustment partner X is notified of the place for holding. Note that, as the place for holding, a common place may be set in all of the booking frames. A different place may be set for each booking frame as well. Moreover, for example, when “other (general purpose)” is selected as the type of assembly, for example, a comment such as “Regarding the place, a place around Shinjuku Station is scheduled. We will inform you of the place for holding when determined.” is set to the adjustment condition template, and the adjustment partner X is notified of the comment.

FIG. 4 is referred to again. When the adjustment initiator A inputs the management information and the information on the booking acceptance screen on the template management information input screen 1200 displayed on the terminal apparatus 40A as illustrated in FIG. 6, for example, and performs operation on the “next” button 1206 (Step S104), next, the adjustment condition setting unit 212 causes the terminal apparatus 40A to display the assembly type selection screen 1210 (FIG. 7) (Step S115). Next, when the adjustment initiator A selects the booking acceptance pattern “accept booking in existing plan” and the type of assembly “phone/web meeting” on the assembly type selection screen 1210 as illustrated in FIG. 7, for example, and performs operation on the “OK” button 1213 (Step S105), next, the adjustment condition setting unit 212 causes the terminal apparatus 40A to display the booking frame list screen 1300 (FIG. 8) (Step S116).

FIG. 8 illustrates a display example of the booking frame list screen 1300 as the adjustment condition template creation screen. On the booking frame list screen 1300, the type of assembly and the booking acceptance pattern selected on the assembly type selection screen 1210 (FIG. 7) and a booking frame list 1308 presenting a list of booking frames set to the template are displayed.

Note that FIG. 8 is a display example of the booking frame list screen 1300 when “set same web meeting URL in all of booking frames” is selected in the radio button 1304, and in the booking frame list 1308 in this case, the date and time, the topic, the participants, and the number of people for booking (the maximum number of people for booking, the number of people who have made a booking) of each booking frame are displayed. Note that FIG. 8 illustrates a state in which no booking frame is added, and the number of booking frames is thus zero.

Regarding the maximum number of people for booking, in one adjustment condition template, only one maximum number of people for booking may be set, and a common maximum number of people for booking may be applied to all of the booking frames. In one adjustment condition template, the maximum number of people as the sum total of the numbers of people for booking in all of the booking frames can be set.

The booking frame list screen 1300 is provided with a “re-select” button 1301 for re-displaying the assembly type selection screen 1210 to re-select the type of assembly and the booking acceptance pattern, an input field 1302 for inputting a comment for the adjustment partner X, a check box 1303 for selecting whether or not the web meeting URL is automatically transmitted as notification to the adjustment partner X at the time of confirmation of the time/date, a radio button 1304 for selecting “set same web meeting URL in all of booking frames” or “set different web meeting URL for each booking frame”, a radio button 1305 for selecting a web meeting tool, an input field 1306 for inputting the web meeting URL to be transmitted as notification to the adjustment partner X, and an input field 1307 for inputting information (a meeting ID, a passcode, or the like) necessary for participating in the web meeting to be notified to the adjustment partner X together with the web meeting URL. Note that, because the information necessary for participating in the web meeting is different depending on a type of web meeting tool, the information to be input to the input field 1307 may be changed depending on the selected type of web meeting tool.

Note that, although in a case of the present embodiment, the web meeting URL, the meeting ID, and the passcode need to be acquired by the adjustment initiator A from the web meeting tool to be input to the input fields 1306 and 1307, the adjustment condition setting unit 212 may generate web meeting information by transmitting a request to the web meeting tool, and acquire the web meeting URL, the meeting ID, and the passcode from the web meeting tool to be reflected in the input fields 1306 and 1307.

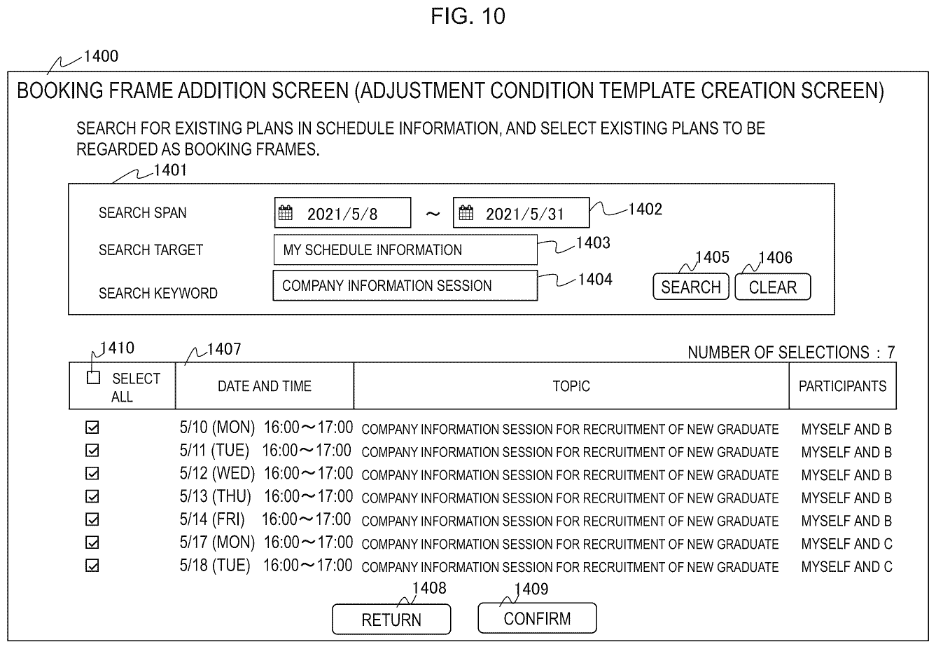

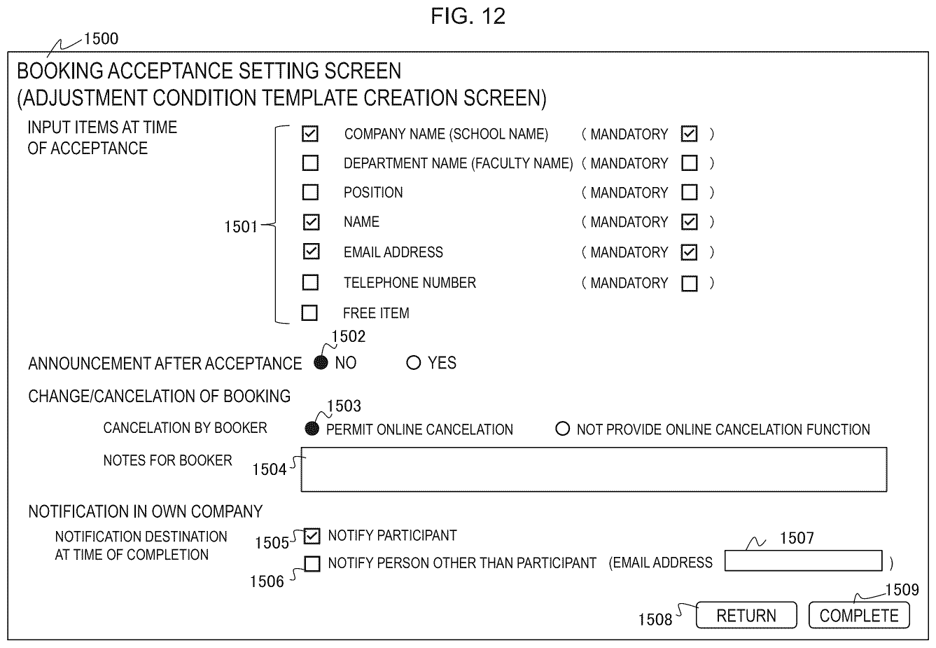

Moreover, the booking frame list screen 1300 is provided with an “add booking frame” button 1310 for proceeding to a booking frame addition screen 1400 (FIG. 10) for adding a booking frame, a selection input field 1311 for designating the extraction span of the candidate time/dates and a method of calculating the number of days to be extracted for the extraction span (for example, calculation with weekdays, calculation with business days, calculation with calendar days, or the like), a “return” button 1312 for returning back to the template management information input screen 1200, and a “next” button 1313 for proceeding to a subsequent booking acceptance setting screen 1500 (FIG. 12).

As the extraction span of the candidate time/dates to be input to the selection input field 1311, the start timing of the extraction span from the timing at which the adjustment partner X performs access based on the booking acceptance URL (in the case of the figure, the next day), the span (in the case of the figure, 8 days), and the method of calculating the number of days to be extracted (in the case of the figure, calculation with weekdays) can be designated. Thus, the adjustment condition template can be repeatedly used for adjustment of time/dates of different assemblies again and again.

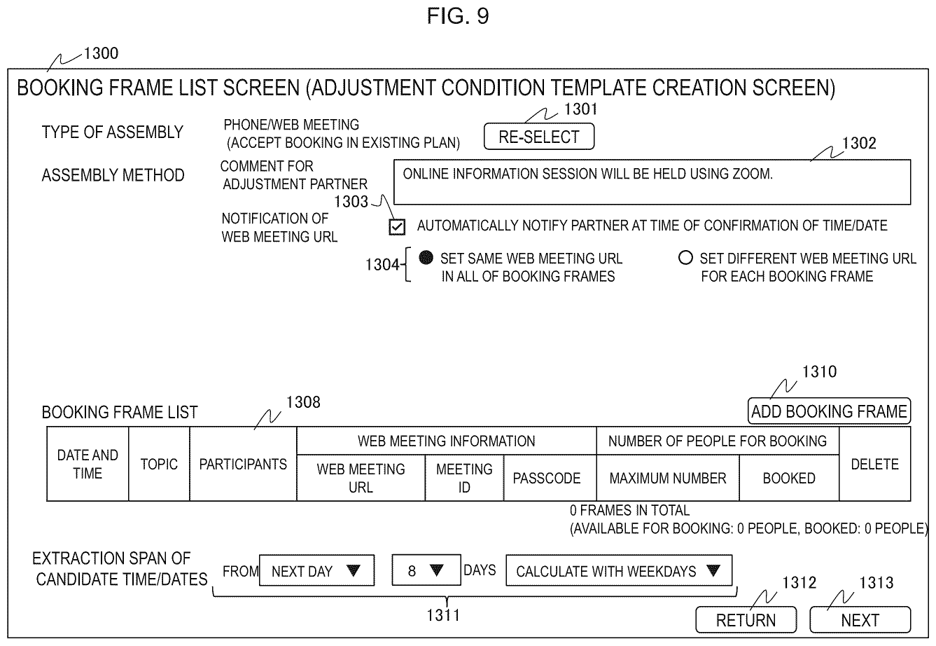

Next, FIG. 9 is a display example of the booking frame list screen 1300 when “set different web meeting URL for each booking frame” is selected in the radio button 1304, and in this case, the radio button 1305 and the input fields 1306 and 1307 are omitted. In the booking frame list 1308 of FIG. 9, web meeting information (a web meeting URL, a meeting ID, and a passcode) is displayed in addition to the date and time, the topic, the participants, and the number of people for booking (the maximum number of people, the number of people who have made a booking) of each booking frame. Note that FIG. 9 illustrates a state in which no booking frame is added, and the number of booking frames is thus zero. Note that, although the web meeting information in FIG. 9 is provided with three input items as maximum items that are often used in general in the web meeting tool, the radio button 1305 of FIG. 8 may also be provided in FIG. 9. The web meeting tool may be designated for each booking frame, and the input items of the web meeting information may be changed depending on the type of web meeting tool.

FIG. 4 is referred to again. When the adjustment initiator A performs operation on the “add booking frame” button 1310 on the booking frame list screen 1300 displayed in the terminal apparatus 40A (Step S106), next, the adjustment condition setting unit 212 causes the terminal apparatus 40A to display the booking frame addition screen 1400 (FIG. 10) (Step S117).

FIG. 10 illustrates a display example of the booking frame addition screen 1400 as the adjustment condition template creation screen. The booking frame addition screen 1400 is provided with a search criterion setting field 1401 for setting the search criterion, a “search” button 1405 for instructing execution of search, a “clear” button 1406 for clearing the search criterion, a search results list 1407 for presenting a list of searched existing plans, a “return” button 1408 for canceling addition of the booking frame and returning back to the booking frame list screen 1300, and a “confirm” button 1409 for adding the existing plan selected by the adjustment initiator A out of the existing plans as the search results to the booking frame.

The search criterion setting field 1401 is provided with a selection input field 1402 for setting the search span of the existing plans, a selection input field 1403 for selecting the search target schedule information, and an input field 1404 for inputting the search keyword.

In the selection input field 1403, the adjustment condition setting unit 212 refers to the belonging member information or the site information included in the member information 221 of the corporate member to which the adjustment initiator A belongs, and can thereby select the schedule information 311 of the belonging member of the corporate member to which the adjustment initiator A belongs and the sites available to the belonging member.

In the search results list 1407, the date and time, the topic, and the participants of the existing plans as the search results are displayed. The search results list 1407 is provided with a check box 1410, and can select whether or not to add all of the existing plans displayed as the search results to the booking frames as addition candidates collectively or for each existing plan.

Note that, on the booking frame addition screen 1400, the addition candidates for the booking frames can be selected by checking the check box 1410 for a part or all of the existing plans out of the existing plans displayed as the search results of a certain search criterion. Next, even when re-searching is performed using another search criterion, the addition candidates for the booking frames can be further increased out of the re-searched results. In this case, even when re-searching using another search criterion is performed, the existing plans checked as the addition candidates for the booking frames are not removed from the display of the search results list 1407 and keep being displayed in an upper part of the search results list 1407 with their display rows having a different color, and new search results searched at the time of the re-searching are displayed below the checked existing plans. In this manner, even when the operations of search and selection of the addition candidates for the booking frames are repeated a plurality of times, the addition candidates for the booking frames can be determined while checking all of the addition candidates for the booking frames selected on the same screen.

FIG. 4 is referred to again. When the adjustment initiator A sets the search criterion to the search criterion setting field 1401 and performs operation on the “search” button 1405 on the booking frame addition screen 1400 displayed in the terminal apparatus 40A (Step S107), next, the adjustment condition setting unit 212 refers to the search target schedule information managed by the external system 30, and searches for the existing plans being present within the search span and including the search keyword in the topic. Then, the plan ID, the date and time, the topic, the participants, and the like of the searched existing plans are acquired (Step S118), and are reflected in the search results list 1407 of the booking frame addition screen 1400 displayed in the terminal apparatus 40A (Step S119). Note that, in the present embodiment, although the existing plans including the search keyword in the topics of the plans are searched for, the existing plans including the search keyword in other attribute items, such as notes of the plans, stored in the plans in the schedule information 311 can be searched for.

In the present case, it is assumed that the adjustment initiator A instructs a search with the search span being set to May 8, 2021 to May 31, 2021, the search target schedule information being set to the schedule information 311 of “myself” (adjustment initiator A), and the search keyword being set to “company information session” on the booking frame addition screen 1400 as illustrated in FIG. 10, seven existing plans are displayed in the search results list 1407 as the search results.

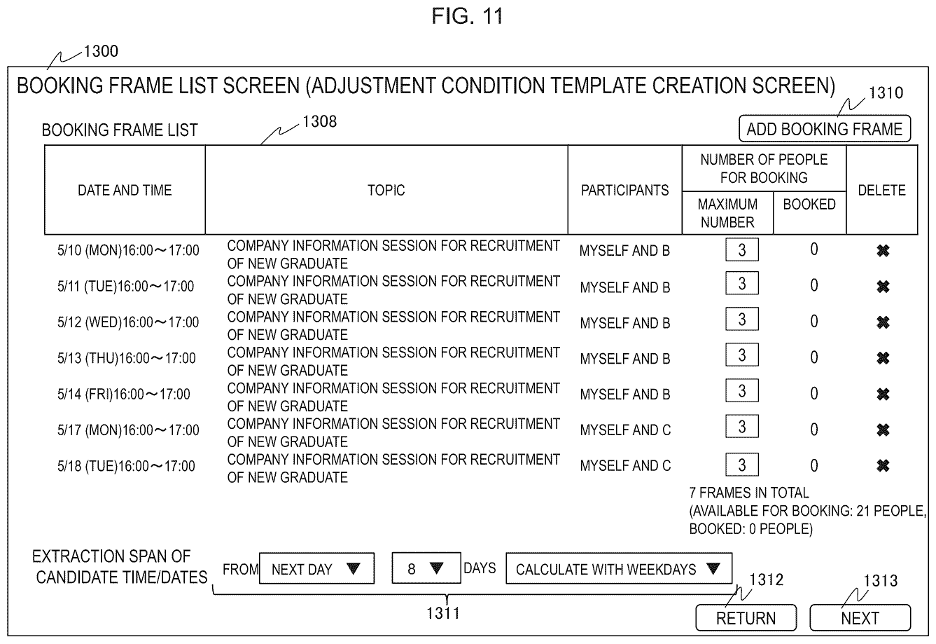

Next, the adjustment initiator A selects the existing plans to be added to the booking frames out of the existing plans displayed in the search results list 1407 on the booking frame addition screen 1400 and performs operation on the “confirm” button 1409 (Step S108), next, the adjustment condition setting unit 212 causes the terminal apparatus 40A to display the booking frame list screen 1300 (FIG. 11) reflecting addition of the booking frames (Step S120).

In the present case, it is assumed that the adjustment initiator A selects all of the seven existing plans displayed in the search results list 1407 on the booking frame addition screen 1400 and performs operation on the “confirm” button 1409, and seven booking frames are added.

FIG. 11 illustrates a display example of the booking frame list screen 1300 reflecting addition of the booking frames when “set same web meeting URL in all of booking frames” is selected in the radio button 1304. Note that, in the display example of FIG. 11, display of the type of assembly and the assembly method displayed in the booking frame list screen 1300 illustrated in FIG. 8 and FIG. 9 is omitted.

In the booking frame list 1308 on the booking frame list screen 1300, the date and time, the topic, the participants, and the number of people for booking (the maximum number of people for booking, the number of people who have made a booking) of each booking frame are displayed. The adjustment initiator A can set the maximum number of people for booking in each booking frame. The adjustment initiator A can individually delete each booking frame.

Note that, although illustration is omitted, when “set different web meeting URL for each booking frame” is selected in the radio button 1304, in the booking frame list 1308, the web meeting information (a web meeting URL, a meeting ID, and a passcode) is displayed in addition to the date and time, the topic, the participants, and the number of people for booking (the maximum number of people, the number of people who have made a booking) of each booking frame. In this case, the adjustment initiator A can set the maximum number of people for booking in each booking frame and the web meeting information. The adjustment initiator A can individually delete each booking frame.

FIG. 4 is referred to again. When the adjustment initiator A sets the adjustment condition such as the maximum number of people for booking in each booking frame displayed in the booking frame list 1308 on the booking frame list screen 1300 and the extraction span of the candidate time/dates and performs operation on the “next” button 1313 (Step S109), next, the adjustment condition setting unit 212 causes the terminal apparatus 40A to display the booking acceptance setting screen 1500 (FIG. 12) for setting various behaviors at the time of accepting the booking and after accepting the booking (Step S121).

FIG. 12 illustrates a display example of the booking acceptance setting screen 1500 as the adjustment condition template creation screen. The booking acceptance setting screen 1500 is provided with a check box 1501 for setting input items for requesting for the adjustment partner X (booker) at the time of accepting the booking, a check box 1502 for setting whether or not there is an announcement after acceptance, a check box 1503 for setting whether or not the booking can be canceled by the booker, and an input field 1504 for inputting notes for the booker. Moreover, as a notification destination in the own company at the time of completion of the booking, the booking acceptance setting screen 1500 is provided with a check box 1505 for a case in which the participant is selected, a check box 1506 for a case in which a person other than the participant is selected, an input field 1507 for inputting an email address of the notification destination other than the participant, a “return” button 1508 for returning back to the booking frame list screen 1300 (FIG. 11), and a “complete” button 1509 for instructing completion of settings on the booking acceptance setting screen 1500 and completion of a series of settings on the adjustment condition template creation screens (FIG. 6 to FIG. 12).

FIG. 4 is referred to again. When the adjustment initiator A sets the input items at the time of acceptance on the booking acceptance setting screen 1500, the notification destination at the time of completion, and the like, and performs operation on the “complete” button 1509 (Step S110), next, the adjustment condition setting unit 212 newly generates the adjustment condition template information 223 in association with the user information 222 of the adjustment initiator A and causes the storage unit 22 to store the adjustment condition template information 223, and registers, in the adjustment condition template information 223, the management information set on the template management information input screen 1200, the information on the booking acceptance screen, the type of assembly, the assembly method, the list of booking frames (the plan IDs of the existing plans, the date and time of the booking frames, and the like) and the adjustment condition (the extraction span of the candidate time/dates, the maximum number of people for booking, and the like) set on the assembly type selection screen 1210 and the booking frame list screen 1300, the input items at the time of acceptance and the notification destination at the time of completion set on the booking acceptance setting screen 1500, and the like (Step S122). Through the above, the adjustment condition template creation processing ends.

According to the adjustment condition template creation processing described above, the adjustment condition template that can be repeatedly used for adjustment of time/dates of different assemblies again and again can be created. Out of the existing plans already registered in the schedule information 311 of the belonging member belonging to the same corporate member as the adjustment initiator A or the sites, the existing plans designated as the booking frames by the adjustment initiator A can be presented to the adjustment partner X as the candidate time/dates of the assembly.

### <Time/Date Adjustment Processing Using Adjustment Condition Template>

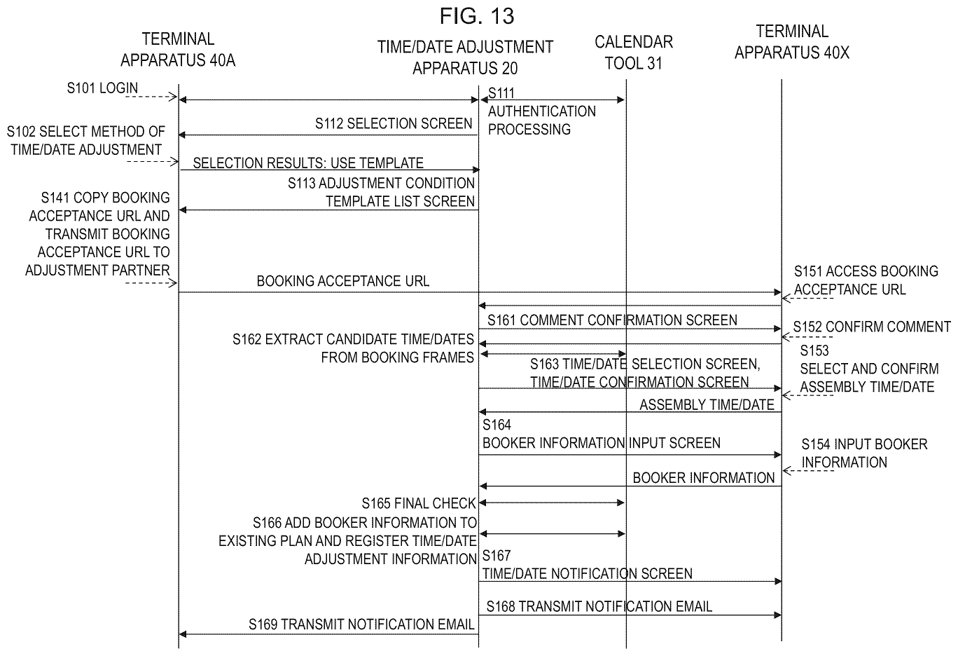

Next, FIG. 13 is a sequence diagram for illustrating an example of the time/date adjustment processing using the adjustment condition template created through the adjustment condition template creation processing illustrated in FIG. 4.

The time/date adjustment processing includes Steps S101, S111, S112, S102, and S113 similar to those of the adjustment condition template creation processing illustrated in FIG. 4.

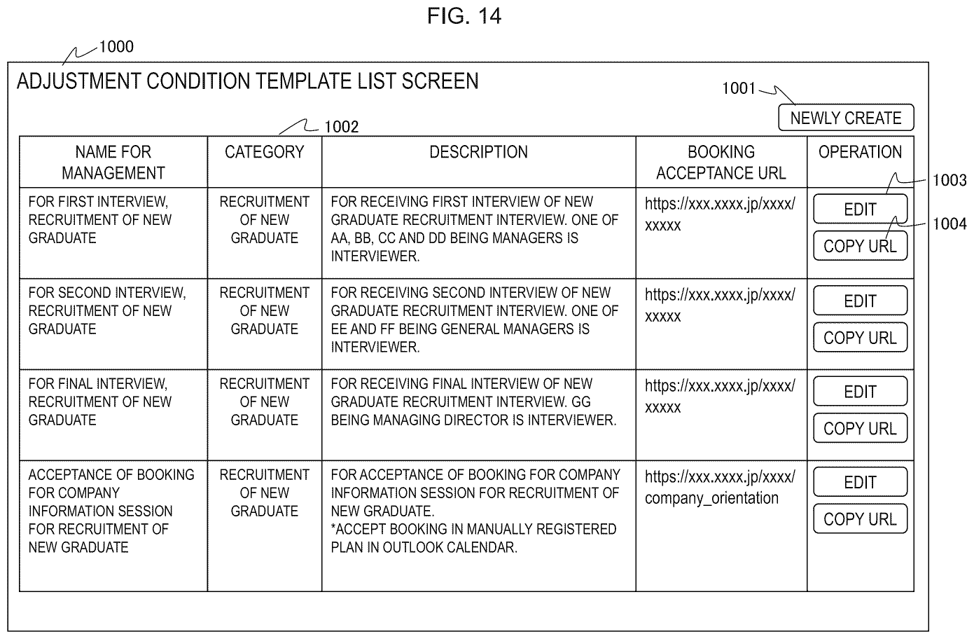

FIG. 14 illustrates a display example of the adjustment condition template list screen 1000 displayed in the terminal apparatus 40A in Step S113. The adjustment condition template list screen 1000 of FIG. 14 is a screen in which the adjustment condition template with the name for management “acceptance of booking for company information session for recruitment of new graduate” is added to the adjustment condition template list screen 1000 of FIG. 5, due to the adjustment condition template creation processing described above.

FIG. 13 is referred to again. Next, on the adjustment condition template list screen 1000 (FIG. 14), the adjustment initiator A performs operation on the “URL copy” button 1004 in the adjustment condition template with the name for management “acceptance of booking for company information session for recruitment of new graduate” to copy the booking acceptance URL, pastes the booking acceptance URL to an electronic mail or the like, and transmits the booking acceptance URL to the terminal apparatus 40X of the adjustment partner X (Step S141). Note that, instead of or in addition to transmitting the booking acceptance URL to the adjustment partner X by using an electronic mail or the like, the booking acceptance URL may be disclosed on a website or the like on the side of the organizer, for example. In the following, operation of the adjustment initiator A is not required.

Next, when the adjustment partner X accesses the booking acceptance URL by using the terminal apparatus 40X (Step S151), the time/date adjustment unit 213 causes the terminal apparatus 40X to display a comment confirmation screen 1600 (FIG. 15) as the booking acceptance screen (Step S161).

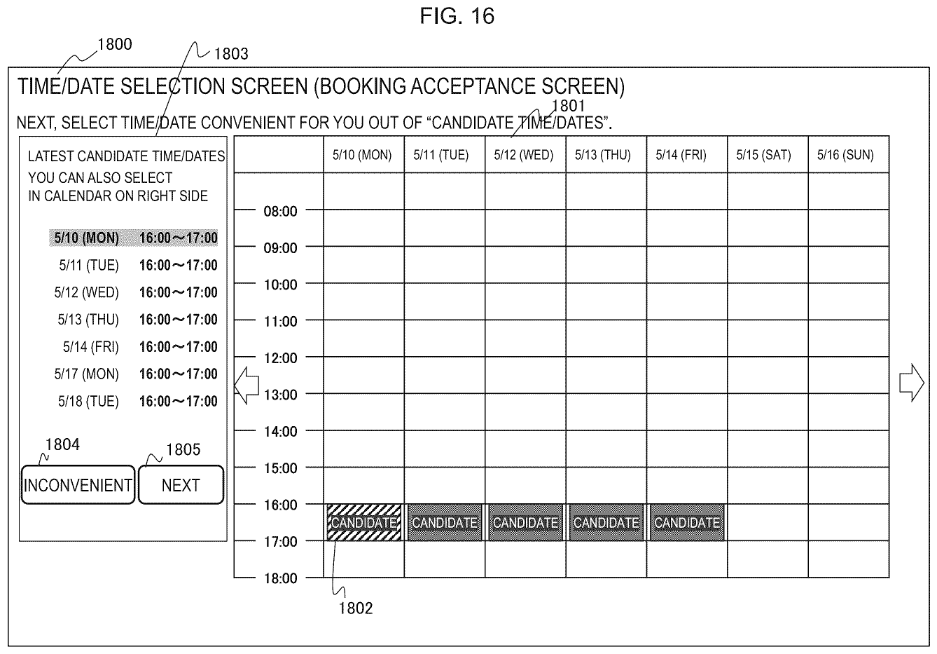

FIG. 15 illustrates a display example of the comment confirmation screen 1600. On the comment confirmation screen 1600, a comment from the organizer or the like is displayed as information related to the assembly input by the adjustment initiator A. The comment confirmation screen 1600 is provided with a check box 1601 for checking when a comment from the organizer is confirmed and a “select time/date” button 1602 for instructing proceeding to a time/date selection screen 1800 (FIG. 16) on which a time/date for booking can be selected.

Note that, in the present embodiment, although only a one-way comment on the side of the organizer for the adjustment partner X is displayed on the comment confirmation screen 1600, a comment from the adjustment partner X in response to the comment from the organizer can be input on the comment confirmation screen 1600. When the adjustment initiator A creates the adjustment condition template, whether or not the comment from the adjustment partner X can be input can be set.

FIG. 13 is referred to again. Next, when the adjustment partner X checks the check box 1601 on the comment confirmation screen 1600 and performs operation on the “select time/date” button 1602 (Step S152), the time/date adjustment unit 213 reads the booking frame list (the plan IDs of the existing plans, the date and time of the booking frames, and the like) and the adjustment condition (the extraction span, the maximum number of people for booking) from the adjustment condition template information 223 of the adjustment initiator A corresponding to the booking acceptance URL, refers to the existing plans corresponding to the booking frames of the schedule information 311 managed by the external system 30, and checks that they remain in the schedule information 311 with the start date and time and the end date and time of the existing plans being unchanged from the date and time of the booking frames stored in the booking frame list of the adjustment condition template information 223. The time/date adjustment unit 213 refers to the time/date adjustment information 224 (if any) associated with the adjustment condition template information 223, and identifies the booking frames in which the number of adjustment partners who have performed adjustment (who have made a booking) is less than the maximum number of people for booking. Then, the time/date adjustment unit 213 extracts, as the candidate time/dates, the booking frames within the extraction span in which corresponding existing plans remain in the schedule information 311 with the start date and time and the end date and time being unchanged and the number of adjustment partners who have performed adjustment is less than the maximum number of people for booking (Step S162).

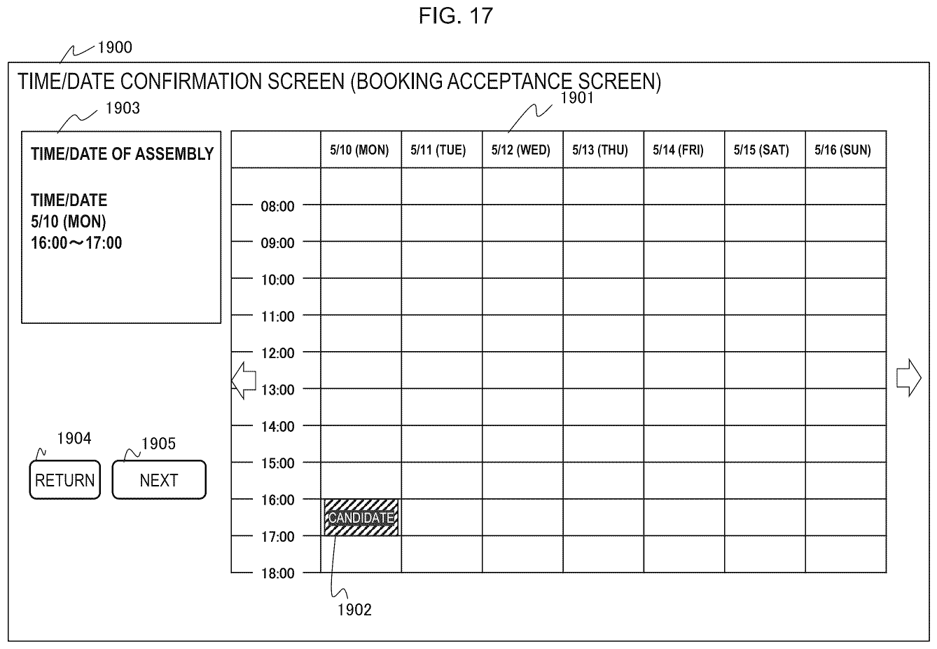

Next, in order to present the extracted candidate time/dates to the adjustment partner X for selection, the time/date adjustment unit 213 causes the terminal apparatus 40X to sequentially display the time/date selection screen 1800 (FIG. 16) and a time/date confirmation screen 1900 (FIG. 17) as the booking acceptance screens (Step S163).

FIG. 16 illustrates a display example of the time/date selection screen 1800. On the time/date selection screen 1800, a calendar 1801 displayed in a grid pattern with its horizontal axis representing dates and vertical axis representing time and a candidate time/date list 1803 in which the candidate time/dates are listed are displayed. The time/date selection screen 1800 is provided with an “inconvenient” button 1804 on which operation is performed when the candidate time/dates presented on the time/date selection screen 1800 are inconvenient and a “next” button 1805 for confirming the selected assembly time/date.

In the calendar 1801, candidate time/date frames 1802 are displayed in different colors or the like so that the candidate time/date frames 1802 can be distinguished from other frames. The adjustment partner X can select the assembly time/date by selecting one of the candidate time/date frames 1802 in the calendar 1801 or one of the candidate time/date frames in the candidate time/date list 1803 in which the candidate time/dates are listed.

When the adjustment partner X performs operation on the “inconvenient” button 1804, the time/date adjustment unit 213 suspends the time/date adjustment processing currently in process, and notifies the adjustment initiator A that the adjustment partner X has performed operation on the “inconvenient” button 1804. When the adjustment partner X performs operation on the “next” button 1805, the time/date adjustment unit 213 displays, for the terminal apparatus 40X, the time/date confirmation screen 1900 (FIG. 17) for confirming the assembly time/date selected by the adjustment partner X themselves.

In the present case, for example, it is assumed that the adjustment partner X selects the candidate time/date from 16:00 to 17:00 on May 10th (Monday) and performs operation on the “next” button 1805 on the time/date selection screen 1800 (FIG. 16).

Next, FIG. 17 illustrates a display example of the time/date confirmation screen 1900. On the time/date confirmation screen 1900, a calendar 1901 displayed in a grid pattern with its horizontal axis representing dates and vertical axis representing time and an assembly time/date 1903 are displayed.

In the calendar 1901, an assembly time/date frame 1902 presenting an assembly time/date selected by the adjustment partner X themselves on the time/date selection screen 1800 is displayed in different colors or the like so that the assembly time/date frame 1902 can be distinguished from other frames. In the assembly time/date 1903, the assembly time/date selected by the adjustment partner X is displayed.

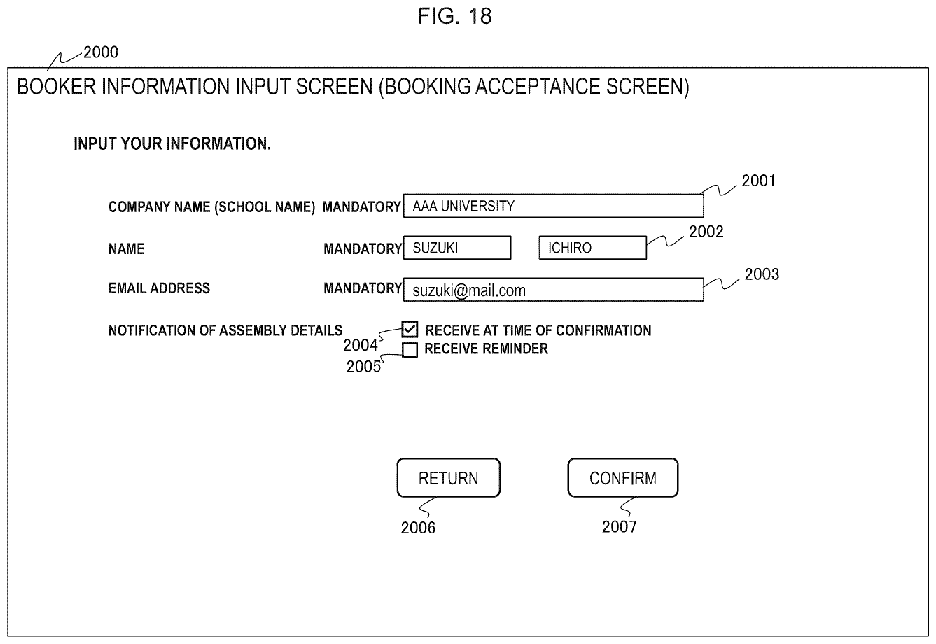

The time/date confirmation screen 1900 is provided with a “return” button 1904 for returning back to the time/date selection screen 1800 (FIG. 16) and a “next” button 1905 for proceeding to a booker information input screen 2000 (FIG. 18).

FIG. 13 is referred to again. When the adjustment partner X performs operation on the “next” button 1905 on the time/date confirmation screen 1900 (FIG. 17) displayed in the terminal apparatus 40X (Step S153), next, the time/date adjustment unit 213 causes the terminal apparatus 40X to display the booker information input screen 2000 (FIG. 18) as the booking acceptance screen for causing the adjustment partner X to input the booker information (Step S164).

FIG. 18 illustrates a display example of the booker information input screen 2000. The booker information input screen 2000 is provided with an input field 2001 for the adjustment partner X to input a company name (school name), an input field 2002 for inputting a name, an input field 2003 for inputting an email address, check boxes 2004 and 2005 for designating a timing of notification of a notification email for giving notification of assembly details, a “return” button 2006 for returning back to the time/date confirmation screen 1900, and a “confirm” button 2007 for instructing confirmation of inputs on the booker information input screen 2000 and confirmation of a series of operations on the booking acceptance screens (FIG. 15 to FIG. 18).

FIG. 13 is referred to again. When the adjustment partner X inputs their booker information (a company name (school name), a name, an email address) and performs operation on the “confirm” button 2007 on the booker information input screen 2000 (Step S154), next, the time/date adjustment unit 213 performs final check that the assembly time/date (booking frame) that the adjustment partner X is to confirm is still available for booking at the current time point (Step S165).

Specifically, the time/date adjustment unit 213 refers to the schedule information 311 managed by the external system 30, and performs final check that the existing plan corresponding to the assembly time/date (booking frame) that the adjustment partner X is to confirm remains in the schedule information 311 without being changed from the start date and time and the end date and time of the booking frame stored in the adjustment condition template information 223. Moreover, the time/date adjustment unit 213 refers to the time/date adjustment information 224 associated with the adjustment condition template information 223, and confirms that the number of adjustment partners who have performed adjustment (have made a booking) related to the assembly time/date (booking frame) to be confirmed is less than the maximum number of people for booking.

Here, when at least one of the start date and time and the end date and time of the existing plan corresponding to the assembly time/date (booking frame) that the adjustment partner X is to confirm has been changed from the time point stored as the booking frame in the adjustment condition template information 223, the existing plan has been deleted, or the number of adjustment partners who have performed adjustment (have made a booking) related to the assembly time/date (booking frame) to be confirmed has reached the maximum number of people for booking, for example, a message such as “The selected time/date is now full. Select again.” may be displayed in the terminal apparatus 40X, and the processing may be brought back to Step S162 and may resume from the operation of the adjustment partner X on the time/date selection screen 1800.

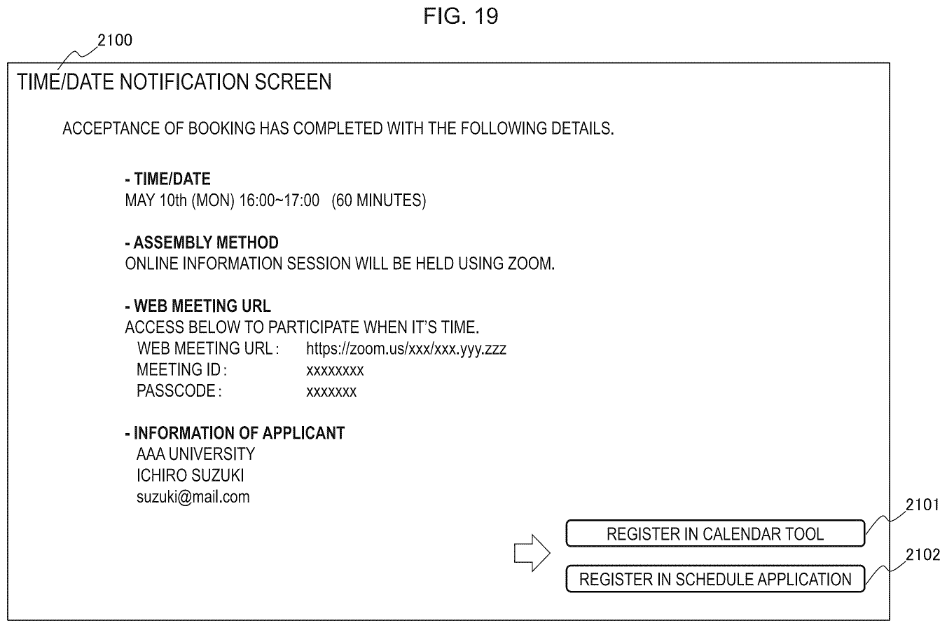

In contrast, when final check can be performed that the existing plan corresponding to the assembly time/date (booking frame) to be confirmed remains in the schedule information 311 without being changed from the start date and time and the end date and time of the booking frame, and the number of adjustment partners who have performed adjustment (have made a booking) related to the assembly time/date (booking frame) to be confirmed is less than the maximum number of people for booking, the time/date adjustment unit 213 regards the time/date as the confirmed assembly time/date, and adds the name and the like input as the booker information to the “notes” field or the like of the existing plan corresponding to the confirmed assembly time/date in the schedule information 311 managed by the external system 30. The time/date adjustment unit 213 newly registers the time/date adjustment information 224 as information in which the adjustment partner X has completed a booking, in association with the user information 222 of the adjustment initiator A and the used adjustment condition template information 223 (Step S166). Moreover, the time/date adjustment unit 213 causes the terminal apparatus 40X to display a time/date notification screen 2100 (FIG. 19) (Step S167).

FIG. 19 illustrates a display example of the time/date notification screen 2100. On the time/date notification screen 2100, the confirmed time/date of the assembly and the like are displayed. On the time/date notification screen 2100, a “register in calendar tool” button 2101 and a “register in schedule application” button 2102 are provided. When the adjustment partner X uses the calendar tool 31 and performs operation on the “register in calendar tool” button 2101, the adjustment partner X can register the plan of the confirmed assembly in the calendar tool 31 as a plan of the adjustment partner X themselves. When the adjustment partner X performs operation on the “register in schedule application” button 2102, the adjustment partner X can register the plan of the confirmed assembly in an application program for schedule management used by the adjustment partner X.

Next, the time/date adjustment unit 213 transmits the notification email for notifying the adjustment partner X of details of the assembly to the email address designated by the adjustment partner X, in accordance with the timing of notification selected by the adjustment partner X themselves (Step S168).

Note that, in the present embodiment, an arrow from the time/date adjustment apparatus 20 to the terminal apparatus 40X is illustrated as Step S168, on the assumption that the adjustment partner X receives the electronic mail using the terminal apparatus 40X; however, the adjustment partner X may receive the notification email from the time/date adjustment apparatus 20, using an electronic device other than the terminal apparatus 40X.

Next, the time/date adjustment unit 213 transmits a notification email for giving notification of assembly details to the participants, such as the participants of the own company, according to the setting of “notification in own company” on the booking acceptance setting screen 1500 (FIG. 12) (Step S169).

According to the time/date adjustment processing described above, as the operation of the adjustment initiator A, by merely selecting the adjustment condition template and transmitting the booking acceptance URL to the adjustment partner X after creating the adjustment condition template, a booking for a company information session or the like can be automatically accepted, and therefore time and efforts of the adjustment initiator A can be significantly reduced.

According to the time/date adjustment processing, the existing plans already registered in the schedule information 311 managed by the external system 30 can be set to the booking frames in the adjustment condition template. Moreover, a booking from the adjustment partner X can be easily and efficiently accepted for the candidate time/dates extracted from the booking frames in line with the maximum number of people for booking.

In addition, in a situation where bookings from a plurality of people are accepted for one assembly time/date (booking frame) such as a company information session and a seminar, it is often the case that the place is determined in advance, and thus completing up to the notification to the adjustment partner X about the place for holding (including the web meeting method) simultaneously with accepting the bookings for the assembly time/date can also contribute to significant reduction in the time and efforts of the adjustment initiator A.

Because the adjustment condition template can be repeatedly used and the booking acceptance URL corresponding to each adjustment condition template is fixed, for example, by attaching a link to a website of a company or attaching a link of the booking acceptance URL subsequently to an input of an inquiry form for guidance, time/date adjustment can be performed without the time and efforts taken to transmit the booking acceptance URL to the adjustment partner X.

By attaching the booking acceptance URL to an email for simultaneous distribution or the like, the booking acceptance URL can be simultaneously transmitted to a plurality of adjustment partners X.

Typically, for example, the time/date adjustment apparatus of the present embodiment can prepare various operation screens as web pages, and can display such operation screens in a web browser of the terminal apparatus. However, this aspect is not restrictive. For example, a dedicated application including various operation screens may be installed in the terminal apparatus. In this case, by transmitting a part of contents (data such as candidate time/dates) to be displayed on various operation screens to the terminal apparatus, the time/date adjustment apparatus can cause the dedicated application of the terminal apparatus to display various operation screens. In other words, the time/date adjustment apparatus of the present invention may also encompass various aspects in which screens can be displayed in the terminal apparatus.

The present invention is not limited to the embodiments and modifications described above, and further various modifications can be made. For example, the embodiments and the modifications described above are described in detail in order to give simple description of the present invention, and are not necessarily limited to those including all of the configurations described above. A part of one modification may be replaced with another modification, or modifications may be combined together.

A part or all of each configuration, function, processing unit, processing means, and the like described above may be, for example, implemented with hardware by designing those with an integrated circuit, for example. Each configuration, function, and the like described above may be implemented with software by a processor interpreting and executing a program for implementing their respective functions. Information such as a program, a table, and a file for implementing respective functions may be stored in a recording apparatus such as a memory, a hard disk, and an SSD, or a recording medium such as an IC card, an SD card, and a DVD. Illustrated control lines and information lines are those considered to be necessary for the sake of description, and not necessarily all of control lines and information lines for a product are illustrated. It may be considered that most of the configurations are connected to each other in actuality.

### REFERENCE SIGNS LIST

10 . . . . Time/date adjustment system
11 . . . Network
20 . . . Time/date adjustment apparatus
21 . . . Processing unit
211 . . . Authentication unit
212 . . . Adjustment condition setting unit
213 . . . Time/date adjustment unit
22 . . . Storage unit
221 . . . Member information
222 . . . User information
223 . . . Adjustment condition template information
224 . . . Time/date adjustment information
23 . . . Communication unit
30 . . . . External system
31 . . . Calendar tool
311 . . . Schedule information
40A . . . Terminal apparatus
40M . . . Terminal apparatus
40X . . . Terminal apparatus
1000 . . . Adjustment condition template list screen
1200 . . . Template management information input screen
1300 . . . Booking frame list screen
1400 . . . Booking frame addition screen
1500 . . . Booking acceptance setting screen
1600 . . . Comment confirmation screen
1800 . . . Time/date selection screen
1900 . . . Time/date confirmation screen
2000 . . . Booker information input screen
2100 . . . . Time/date notification screen

1. A time/date adjustment apparatus comprising:
an adjustment condition setting unit configured to set an adjustment condition template to be repeatedly used for adjustment of time/dates of different assemblies; and
a time/date adjustment unit configured to perform adjustment of an assembly time/date, based on the adjustment condition template, wherein
the adjustment condition setting unit regards existing plans designated by an adjustment initiator out of the existing plans already registered in schedule information managed by an external system as booking frames, and registers an adjustment condition including designation of the booking frames in the adjustment condition template, and
when an adjustment partner performs access based on access information corresponding to the adjustment condition template, the time/date adjustment unit regards the booking frames satisfying the adjustment condition out of the booking frames as candidate time/dates, displays a time/date selection screen presenting the candidate time/dates in a terminal apparatus used by the adjustment partner, and in response to an operation of selecting one of the candidate time/dates of the adjustment partner on the time/date selection screen, determines the selected candidate time/date as the assembly time/date.

2. The time/date adjustment apparatus according to claim 1, wherein
the adjustment condition setting unit sets the schedule information designated by the adjustment initiator and managed by the external system to search target schedule information,
the adjustment condition setting unit searches for the existing plans satisfying a search criterion set by the adjustment initiator out of the existing plans already registered in the search target schedule information, and
the adjustment condition setting unit regards, as the booking frame, the existing plan selected by the adjustment initiator out of the existing plans as search results.

3. The time/date adjustment apparatus according to claim 2, wherein
the adjustment initiator performs processing of setting the search criterion and processing of selecting the booking frame out of the existing plans as the search results one or more times for the same adjustment condition template.

4. The time/date adjustment apparatus according to claim 2, wherein
the adjustment condition setting unit searches for the existing plan including a search keyword as the search criterion in information related to the existing plan out of the existing plans already registered in the search target schedule information.

5. The time/date adjustment apparatus according to claim 2, wherein
the adjustment condition setting unit searches for the existing plan within a search span as the search criterion out of the existing plans already registered in the search target schedule information.

6. The time/date adjustment apparatus according to claim 2, wherein
the adjustment condition setting unit regards the schedule information of a belonging member belonging to an organization same as the adjustment initiator or the schedule information of a site available to the belonging member designated by the adjustment initiator as the search target schedule information.

7. The time/date adjustment apparatus according to claim 1, wherein
the adjustment condition setting unit sets an extraction span as the adjustment condition, and
when the adjustment partner performs access based on the access information, the time/date adjustment unit regards the booking frames within the extraction span from a timing at which the adjustment partner performs access out of the booking frames as the candidate time/dates.

8. The time/date adjustment apparatus according to claim 1, wherein
the adjustment condition setting unit sets a maximum number of people for booking as the adjustment condition, and
when the adjustment partner performs access based on the access information, the time/date adjustment unit regards the booking frames in which the number of the adjustment partners who have made a booking is less than the maximum number of people for booking out of the booking frames as the candidate time/dates.

9. The time/date adjustment apparatus according to claim 1, wherein
the time/date adjustment unit adds information related to the adjustment partner to the existing plan already registered in the schedule information corresponding to the determined assembly time/date and managed by the external system.

10. The time/date adjustment apparatus according to claim 1, wherein
the time/date adjustment unit notifies the adjustment partner of the determined assembly time/date, and information related to a web meeting designated by the adjustment initiator for the adjustment condition template or the booking frame or information related to a place for holding.

11. A time/date adjustment method performed by a time/date adjustment apparatus, the time/date adjustment method comprising:
an adjustment condition setting step of setting an adjustment condition template to be repeatedly used for adjustment of time/dates of different assemblies; and
a time/date adjustment step of performing adjustment of an assembly time/date, based on the adjustment condition template, wherein
the adjustment condition setting step includes regarding existing plans designated by an adjustment initiator out of the existing plans already registered in schedule information managed by an external system as booking frames, and registering an adjustment condition including designation of the booking frames in the adjustment condition template, and
when an adjustment partner performs access based on access information corresponding to the adjustment condition template, the time/date adjustment step includes regarding the booking frames satisfying the adjustment condition out of the booking frames as candidate time/dates, displaying a time/date selection screen presenting the candidate time/dates in a terminal apparatus used by the adjustment partner, and in response to an operation of selecting one of the candidate time/dates of the adjustment partner on the time/date selection screen, determining the selected candidate time/date as the assembly time/date.

12. A non-transitory computer-readable storage medium storing a program causing a computer to function as:
an adjustment condition setting unit configured to set an adjustment condition template to be repeatedly used for adjustment of time/dates of different assemblies; and
a time/date adjustment unit configured to perform adjustment of an assembly time/date, based on the adjustment condition template, wherein
the adjustment condition setting unit regards existing plans designated by an adjustment initiator out of the existing plans already registered in schedule information managed by an external system as booking frames, and registers an adjustment condition including designation of the booking frames in the adjustment condition template, and
when an adjustment partner performs access based on access information corresponding to the adjustment condition template, the time/date adjustment unit regards the booking frames satisfying the adjustment condition out of the booking frames as candidate time/dates, displays a time/date selection screen presenting the candidate time/dates in a terminal apparatus used by the adjustment partner, and in response to an operation of selecting one of the candidate time/dates of the adjustment partner on the time/date selection screen, determines the selected candidate time/date as the assembly time/date.
